(19) United States
(12) Patent Application Publication
(10) Pub. No.: US 2007/0288208 A1
(43) Pub. Date: Dec. 13, 2007

(54) Measurable enterprise CBRNE protection

(75) Inventors: Michael H. Grigsby, Haymarket, VA (US); Timothy W. Lohr, Manassas, VA (US); Stephen J. Philipse, Manassas, VA (US); Jonathan E. Wist, Manassas, VA (US)

Correspondence Address: DEMONT & BREYER, LLC, 100 COMMONS WAY, Ste. 250, HOLMDEL, NJ, 07733, US

(73) Assignee: Lockheed Martin Corporation, Bethesda, MD (US)

(21) Appl. No.: 11/208,838

(22) Filed: Aug. 22, 2005

Related U.S. Application Data
(60) Provisional application No. 60/603,170, filed on Aug. 20, 2004.

(51) Int. Cl. G06F 17/10

(52) U.S. Cl. 703/2

(57) ABSTRACT

A system and method is disclosed for improving the design, procurement, placement, and deployment of CBRNE threat-protection resources to counter a CBRNE threat. The threat-protection resources include a combination of procedural, human and material elements.

### STATEMENT OF RELATED CASES

This application claims priority of U.S. Provisional Patent Application No. 60/603,170, filed Aug. 20, 2004, which is incorporated by reference herein.

### FIELD OF THE INVENTION

The present invention relates to a method for improving resource allocation and deployment for a specified chemical, biological, radiological, nuclear and explosive (“CBRNE”) threat scenario.

### BACKGROUND OF THE INVENTION

Whether due to accident or attack, the release of chemical, biological, or radiological agents, or the detonation of nuclear or other high-yield explosives, can be devastating.

Various governmental agencies have been established to respond to CBRNE threats and incidents. Furthermore, some corporations offers CBRNE terrorism response training that includes, for example, monitoring and surveillance techniques, incident management, personnel protection and treatment, communications, interfacing with Federal assets, and the like.

Modeling tools are available to gauge the affects of specific CBRN threats or incidents. Some of the models are “transport and diffusion” models, which project the path of chemical or biological agents after release and predict the degree of hazard posed. Examples of this type of model include the Hazard Prediction & Assessment Capability (“HPAC”) model, the Vapor, Liquid, and Solid Tracking (VLSTRACK) model, and D2PUFF.

Training efforts and modeling tools notwithstanding, the current approach to CBRNE threat readiness is somewhat ad-hoc or reactive. That is, simulations are run to predict damage or casualties, first responders are trained in appropriate health-care methodologies, technicians are trained to operate monitoring, sampling and identification equipment, and so forth. And if a CBRNE incident occurs, appropriate personnel will react swiftly to limit the extent of casualties and damage. But the current approach does not address the issue of what can be done before an incident occurs to minimize or otherwise reduce its impact.

### SUMMARY OF THE INVENTION

The illustrative embodiment of the present invention is a system and method for improving the design, procurement, placement, and deployment of CBRNE threat-protection resources to counter a CBRNE threat. The threat-protection resources include a combination of procedural, human and material elements.

In accordance with the method, system metrics, which are used to gauge the performance of a proposed threat-protection system, are established. The system metrics are, of course, specific to a given threat scenario, but typically include:
the probability of sustaining the mission (e.g., keeping a particular monitoring facility operating, etc.);
the casuality rate among mission-critical personnel;
the improvement in “restoration time” of the facility, etc.;
estimated cost of the system.

Through the use of modeling tools, a quantitative estimate of the system metrics is obtained for the threat scenario based on a given allocation of threat-protection resources. In accordance with the illustrative embodiment, the sensitivity of the system metrics to the various threat-protection resources is determined by varying one or more characteristics of at least some of the threat-protection resources, one characteristic and one resource at a time. An optimum or near-optimum allocation of CBRNE threat-protection resources is obtained based on the sensitivity analysis. Threat-protection resources are deployed based on the determined allocation. See, e.g., FIG. 36.

### BRIEF DESCRIPTION OF THE DRAWINGS

FIG. 1 depicts an architecture for a system in accordance with the illustrative embodiment of the present invention.

FIG. 2 depicts IPP operational factors.

FIG. 3 depicts Hazard, Protection, and Response Timelines.

FIG. 4 depicts an FOST simulation-based design.

FIG. 5 depicts the CONOPS development process.

FIG. 6 depicts C4I integration objectives, issues and solutions.

FIG. 7 depicts C4I integration.

FIG. 8 depicts key CBRN event decisions.

FIG. 9 depicts DSS features.

FIG. 10 depicts decision rule creation and usage.

FIG. 11 depicts MOE computations.

FIG. 12 depicts a technology advancement process.

FIG. 13 depicts a solution to a sample problem.

FIG. 14 depicts a measures-of-effectiveness comparison.

FIG. 15 depicts a critical mission preservation effectiveness approach.

FIG. 16 depicts a first and emergency response force effectiveness approach.

FIG. 17 depicts IP Sim analysis, as applied to four threat scenarios.

FIG. 18 depicts a biological agent scenario effectiveness approach.

FIG. 19 depicts a CWA and TIC scenario effectiveness approach.

FIG. 20 depicts a radiological material scenario effectiveness approach.

FIG. 21 depicts an alarm assessment, display and communication effectiveness approach.

FIG. 22 depicts a decision support system and CONOPS effectiveness approach.

FIG. 23 depicts the application of scientific principles to the FoS solution.

FIG. 24 depicts measures of performance for the FoS solution.

FIG. 25 depicts a summary of key IPP process times.

FIG. 26 depicts a CONOPS decision tree.

FIG. 27 depicts the extent to which existing capabilities are leveraged in the FoS solution.

FIG. 28 depicts a methodology for the selection of FoS components.

FIG. 29 depicts a final FOST sensor solution to the sample problem.

FIGS. 30-32 depict a b-o-m and selection rationale for each FoS component.

FIG. 33 depicts a system interface description.

FIG. 34 depicts the physical data transport infrastructure.

FIG. 35 depicts the measured level of improvement and performance benefits of applying the illustrative embodiment of the invention to the sample problem.

FIG. 36 depicts a system and method for improving resource allocation and deployment CBRNE threat-protection resources.

### DETAILED DESCRIPTION

This Detailed Description begins with an overview of a system and method for improving the design, procurement, placement, and deployment of CBRNE threat-protection resources to counter a CBRNE threat.

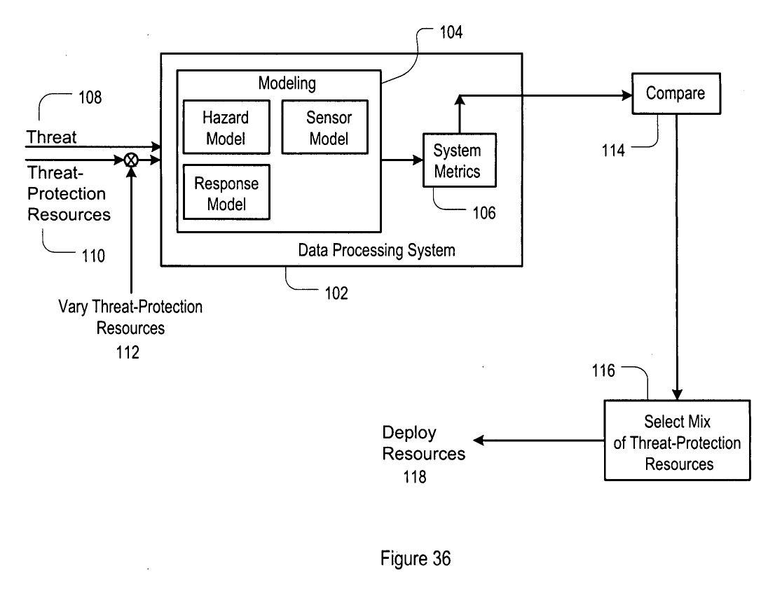

With reference to the system and method depicted in FIG. 36, system metrics 106, which are used to gauge the performance of a proposed threat-protection system, are established. The system metrics are, of course, specific to a given threat scenario 108, but typically include:
the probability of sustaining the mission (e.g., keeping a particular monitoring facility operating, etc.);
the casuality rate among mission-critical personnel;
the improvement in “restoration time” of the facility, etc.;
estimated cost of the system.

Through the use of modeling tools 104, a quantitative estimate of the system metrics is obtained, in data processing system 102, for threat scenario 108 based on a given allocation of threat-protection resources 110. In accordance with the illustrative embodiment, the sensitivity of the system metrics to the various threat-protection resources is determined by varying, at 112, one or more characteristics of at least some of the threat-protection resources, one characteristic and one resource at a time. An optimum or near-optimum allocation of CBRNE threat-protection resources is obtained at 116 based on the sensitivity analysis at 114. Threat-protection resources are deployed at 118 based on the determined allocation.

A.1 Technical Approach

1.2 FoS Performance Responsibility

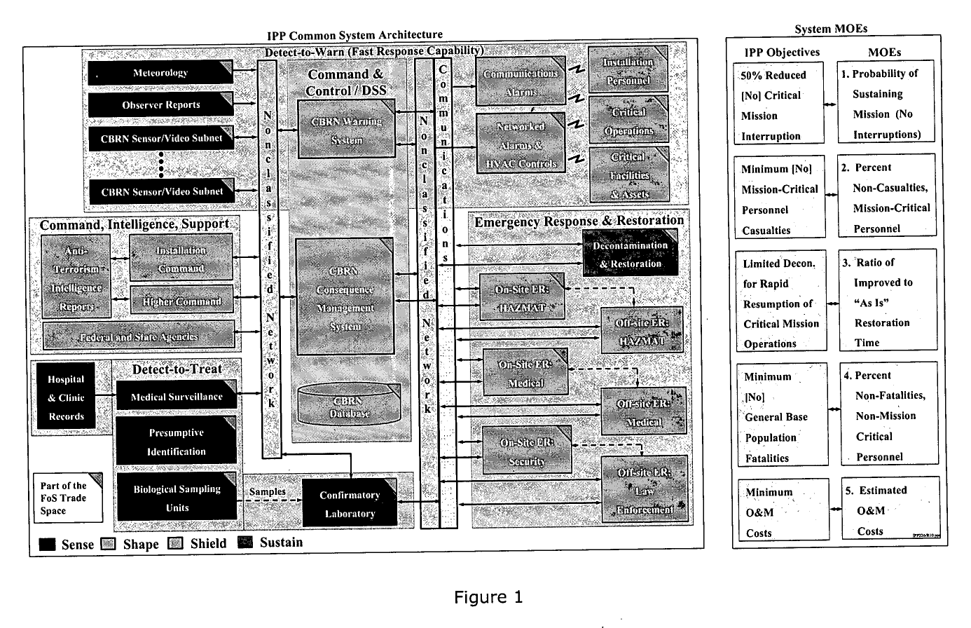

Our FoS specifications and architecture are derived from the CBRN Urgent Requirements Capabilities Document and the IPP Initial Systems Architecture. Our requirements traceability process, (using RTM™) provides an audit trail from IPP requirements to system specifications to FoS architecture design that ensures requirements are properly addressed and enables system capabilities to be traced to requirements. Operational, Systems and Technical Views of our FoS architecture are developed in accordance with the DoD Architecture Framework, Version 1.0. FIG. 1 shows an overall system view of our IPP FoS Common Architecture. Our broad-based architecture incorporates human roles of responders, decision-makers and other operational elements, with FoS interoperability defined by CONOPS, TTPs and MOA/MOUs. Our architecture also includes CBRN sensor subnets, C2 Warning and Consequence Management Systems with decision support, alarm systems, protection equipment, emergency responder equipment, bio-sample filters, medical equipment, medical surveillance, and decontamination equipment. The common architecture representation is optimized and tailored to the specific implementation for each IPP installation. Our architecture is based on open systems standards, is modular and scalable to enable tailoring, and extensible to facilitate new technologies and other capability improvements.

Our process for designing optimal IPP FoS solutions is based on the use of metrics to evaluate and compare solutions using our FoS Tradeoff (FOST) process. These metrics, shown in FIG. 1, are quantified Measures of Effectiveness (MOEs) for a given IPP FoS solution and determine how well that solution achieves overarching IPP objectives. Our simulation-based design methodology uses accurate, high-fidelity simulation models to compute these metrics for a comprehensive set of threat scenarios, and averages MOEs across the threat ensemble to evaluate solution effectiveness. All FOST factors are included in the models to ensure that these MOEs provide valid optimization and selection criteria. Our design process also utilizes system-level Measures of Performance (MOPs) as design metrics that contribute to the MOEs. The linkage from system and technology MOPs to FoS solution MOEs is established through our IPSim-Analysis M&S capability.

System MOPs enable verification that IPP FoS capabilities satisfy system requirements. Our IPSim-Analysis M&S capability provides the means to represent FoS capabilities characterized by the MOPs, and to evaluate comprehensive MOEs for each FoS solution. These MOE evaluations can be used, together with the Installation Exercise Assessment (IEA), in the installation's IPP System Assessment in accordance with the Overarching Test Concept Plan. We manage total FoS performance through the architecture and system specifications, the MOPs, and the IPSim-based MOEs, as detailed in paragraphs 1.3.1 through 1.3.3.

1.3 CBRN COTS/GOTS Integration

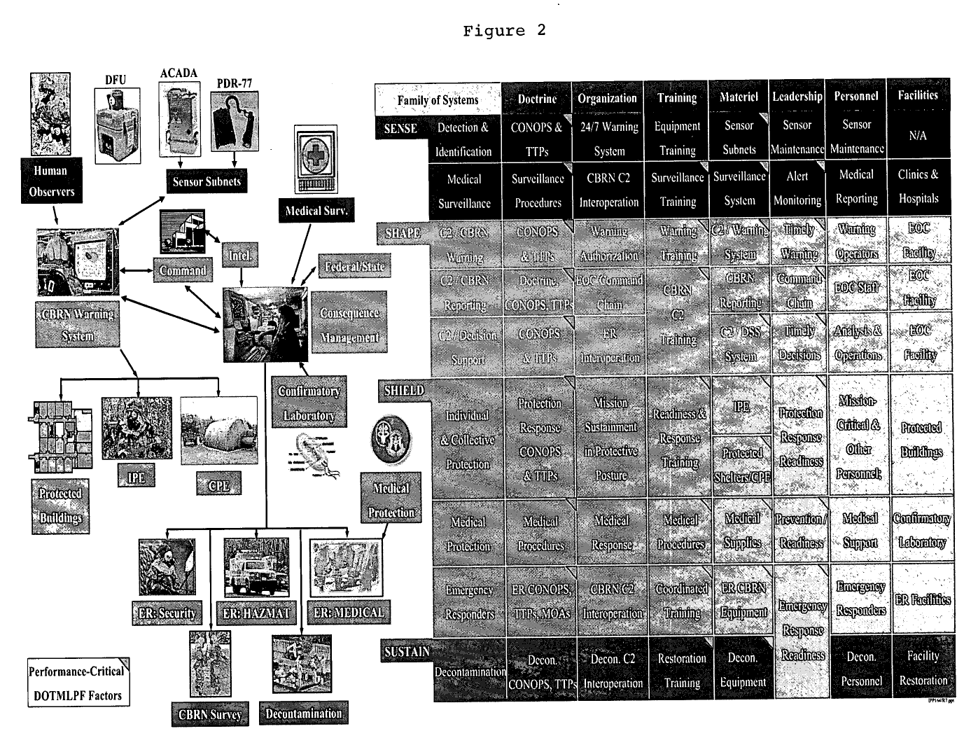

Our architecture includes FoS materiel elements such as detection and identification equipment, C2 systems with decision support, C4I interfaces, IPE/CPE and decontamination equipment. Our architecture incorporates doctrine, organization, training, leadership, personnel and facilities (DOTLPF) factors that affect the response of operational groups and personnel requiring warning and protection, response of emergency medical, security and HAZMAT organizations, performance of decontamination teams, medical management and surveillance. FIG. 2 summarizes effects of DOTMLPF factors on the performance of FoS components.

System-level MOPs are driven by these DOTMLPF factors, thus providing an approach for measuring and analyzing system performance benefits of CONOPS, TTPs, training and exercises as part of the FoS design tradeoff process. This comprehensive approach enables accounting for all IPP FoS acquisition and sustainment costs and all FoS performance factors within the architecture.

Detection and Identification elements include CBRN detect-to-warn sensors integrated via wired or wireless networks to the CBRN Warning System for sensor alerting and control, human observers using C4I systems for CBRN event reporting, and video surveillance cameras for monitoring protection areas to assist in verifying detections or determining false alarms. CBRN detect-to-treat capabilities include deployed bio-filters with scheduled collections and confirmatory laboratory testing to determine if a bio-hazard is present, assay systems for presumptive identification, and a medical surveillance system.

A detect-to-warn response occurs rapidly following an attack, from a 24/7 CBRN Warning System that receives data from networked sensors, fuses sensor and human observer data, includes decision support for determination of real events vs. false alarms, utilizes meteorological data and decision support to predict the hazard area and issues timely alarms via C4I networks and communications to allow time for protective response. The Warning System is integrated with the installation C4I systems and provides situational awareness of the sensor network and protected areas, sensor C2, video surveillance monitoring, hazard prediction using VLSTRACK or HPAC, decision support based on predetermined hazard analyses developed during our FoS design process, and selective or mass alarm capabilities.

Individual and Collective Protection including IPE/CPE and building or HVAC system modifications for shelter-in-place protection, as well as Medical Management for treatment of casualties, is included in the FoS architecture and trade space in terms of equipment, training, CONOPS and TTPs, and related MOPs.

Our CBRN Consequence Management System provides additional decision support, workflow management and communications management for managing and coordinating CBRN event response. This system, manned and operated when it is determined that a CBRN event has occurred, is integrated with and uses installation C4I networks and communications to coordinate with on-site and off-site emergency HAZMAT, medical and security responders, decontamination teams, installation and higher command, and federal and state agencies.

The Consequence Management System provides a Common Operational Picture (COP) of the hazard area showing casualty and HAZMAT report locations, emergency responder positions and other information. Consequence Management workflow and status is supported by a workflow management capability. Formatting and routing of messages and reports are configured in accordance with the installation's CONOPS and TTPs and managed by a communications management capability.

An alert from the medical surveillance system or the bio-sample confirmatory laboratory initiates staffing and operation of the Consequence Management System and leads to early treatment of infected personnel.

1.3.1 Measures of Performance (MOPS)

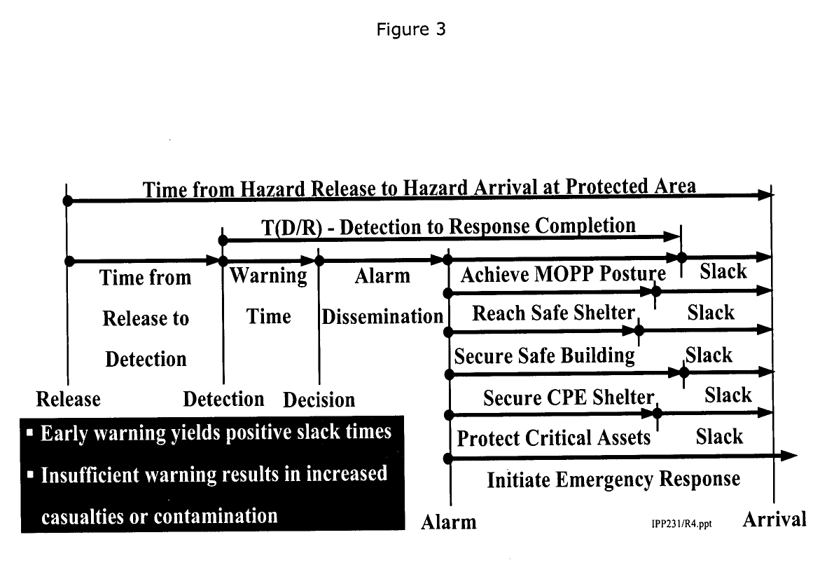

FIG. 3 shows detect-to-warn time factors including times for sensors to respond and alert, times for data fusion, decision-making and alarm dissemination, and response times. These times are MOPs that reflect readiness, training and other DOTMLPF factors. Other key MOPs include time to identify a biological hazard to initiate early treatment and minimize casualties, time to alert emergency responders with sufficient information to enable a correct response, time for emergency responders to arrive and initiate rescue and treatment operations, and time to decontaminate critical assets following an attack.

1.3.2 FoS Tradeoff Methodology

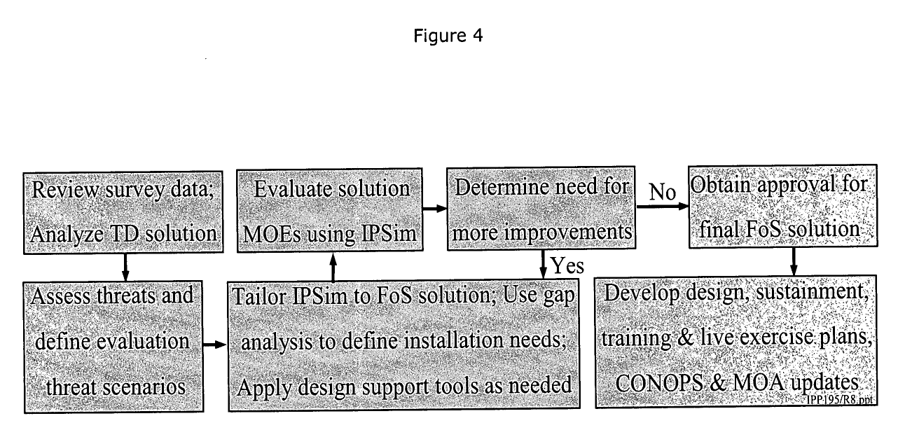

Our FoST process, shown in FIG. 4, begins with the site survey information and a review of the TD partial solution. Threat and vulnerability assessments are utilized to define a set of representative threat scenarios for tradeoff and evaluation. Our FoS architecture includes elements applicable to most installations, as well as selectable elements. We tailor the architecture by eliminating non-applicable elements, and develop an installation-specific implementation based on site survey data. A gap analysis to identify potential installation FoS deficiencies establishes the trade space. We utilize sensor placement and analysis tools derived from existing models to determine critical solution parameters.

Our IPSim-Analysis executable representation of our FoS architecture is tailored to each FoS solution and used to calculate the MOEs. MOEs are calculated for the installation “as-is” situation and for the partial solution provided in the IPP TD to establish a baseline for our FOST process. Our IPSim-Analysis architecture integrates models of CBRN hazards, environments, sensors, warning, reporting and C2 elements, networking and communications, protection, emergency response, exposure and toxicity, treatment, and decontamination. During the iterative design process we compute MOEs for each candidate solution, analyze results to determine if improvements are needed, make the necessary adjustments, and continue until the desired results are achieved. We also estimate acquisition and O&M costs for each solution and apply CAIV principles to ensure solution affordability.

Our optimized FoS alternatives are presented to the JPMG and installation commander for selection. Upon design approval, we develop installation plans and drawings, ILS & sustainment plans, training and exercise plans and packages, and updates to the installation's CONOPS, TTPs and MOA/MOU agreements.

1.3.3 Using Multiple MOEs to Determine Optimal Solutions

Multiple IPP overarching objectives have led to five MOEs for solution evaluation. A methodology is needed to determine an “optimal” solution based on these MOEs. Three MOEs measure aspects of critical mission interruption or reduction in tempo: (1) probability of sustaining the mission without interruption; (2) percentage of non-casualties among mission-critical personnel; and (3) ratio of improved to “as-is” time to decontaminate mission-critical assets. A fourth MOE measures percentage of non-fatalities and evaluates overall installation personnel safety, in contrast to critical-mission national security implications. The fifth MOE that measures estimated IPP FoS O&M cost becomes particularly important when it exceeds an affordability level for the installation. We determine installation-specific rankings, weightings and constraints for the MOEs based on an interview with the installation commander and a review of his AT plan during the site survey. Our design process uses the ranked, weighted MOEs to evaluate candidate solutions and to determine optimal solutions. FoS solution alternatives permit consideration of subjective decision factors among the JPMG, the installation commander and the LSI contractor, leading to final design selection and approval.

1.3.4 Sensor Network Integration

Our CBRN sensor network consists of one or more IP-subnets that integrate with the installation's non-classified IP network (e.g., NIPRNet) for transmission of sensor, video and control data between the CBRN sensors and video surveillance cameras and the CBRN Warning System. Each subnet consists of sensors and cameras attached to Sensor Interface Devices (SIDs) that buffer sensor and video data and control information, convert native sensor data to IP formatted messages and communicate via wired or wireless media with a Network Interface Device connected to the installation's C4I system. Various COTS products are available to provide CBRN subnet capabilities, including RTI's SensorView, Sentel's RDR, and Lockheed Martin's MetroGuard. MetroGuard has evolved from MICAD, BAWS and CBAWS, and the sensor interface elements of MetroGuard have been tested with numerous CBRN sensors including the ACADA, UDR-13, PDR-77, VDR-2, M21 and various COTS sensors. MetroGuard is the first networked sensor system submitted to DHS and currently under review for certification and coverage under the Safety Act. Our open system architecture supports the use of available COTS/GOTS sensor networking products that support IPP-based networking interfaced to the installation's C4I systems.

A. 2 CBRN CONOPS Support & Systems Architecture Integration into C4I Network

2.1 CONOPS Development Support

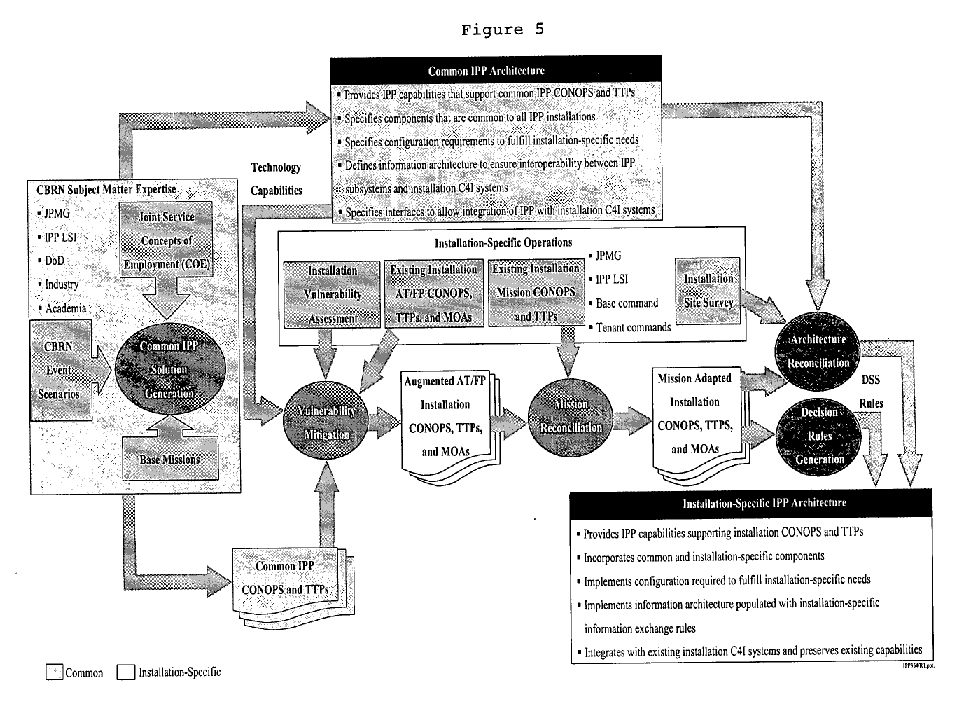

The CONOPS development support process ensures maximum protection with minimum impact on mission operations by using the comprehensive CBRN installation protection community knowledge. In 2003, a collaborative research program developed science-based measures-of-effectiveness (MOEs) for installation protection. Fifteen installations were surveyed nationwide to understand the diverse CBRN protection demands of each armed service and their installation missions. This research produced a CONOPS development process, shown in FIG. 5, whose execution yields two foundation elements that are configured at each installation to fulfill installation IPP needs. The first element is a set of Common IPP CONOPS and TTPs comprising IPP operations that are common to all installations. The second element is the Common IPP Architecture that specifies systems and their interoperation to define an IPP FoS design supporting the Common IPP CONOPS and TTPs. These common elements allow each installation to benefit from the collective CBRN protection experience of all installations.

IPP fielding augments an installation's existing AT/FP CONOPS, TTPs, and MOAs with the Common IPP CONOPS and TTPs. The augmented CONOPS and TTPs are then reconciled with mission CONOPS to preserve the installation's mission capabilities. The resulting Installation-Specific CONOPS and TTPs are then translated into configuration data used to transform the Common IPP Architecture into the Installation-Specific IPP Architecture. Such data includes decision support rules whose capture is described later in this specification.

2.2 C4I Network Integration

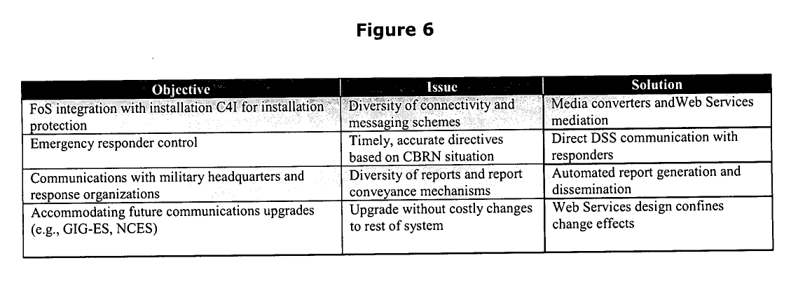

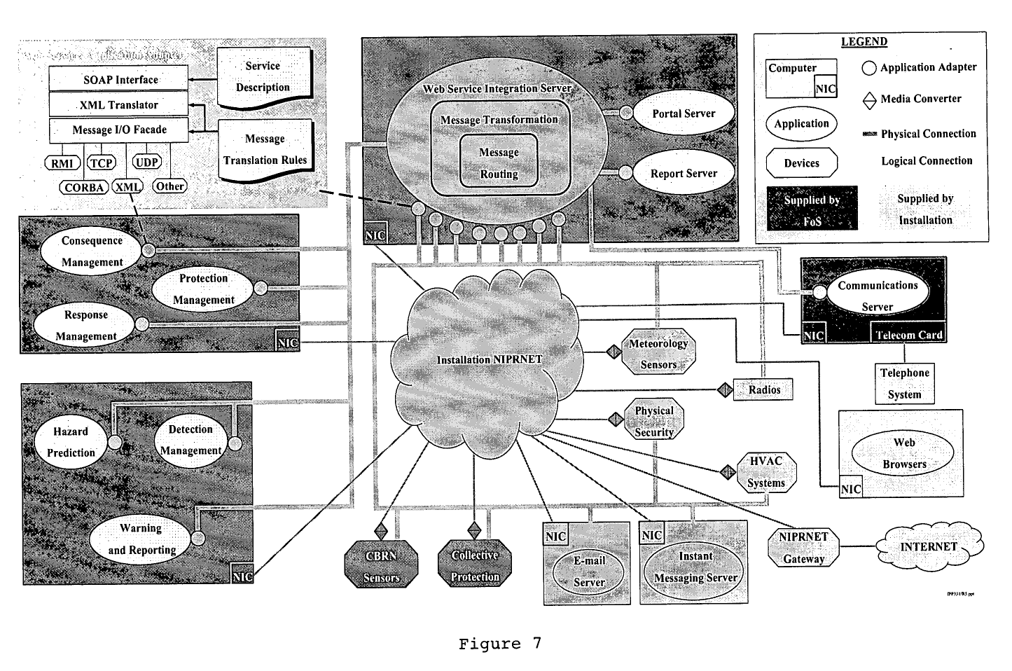

Our approach to FoS integration with the installation's existing C4I network achieves the four major objectives shown in FIG. 6. Our solution, shown in FIG. 7, connects the FoS computers with appropriate installation computers and communications equipment using a combination of wired (e.g., installation's NIPRNET) and wireless LAN solutions as determined by each installation's technical capabilities and CONOPS (e.g., mission, security). Equipment having only serial or parallel port interfaces is connected to the LAN using media converters. Establishing an IPP LAN allows the use of COTS web services to enable data interchange amongst the FoS and installation applications using their existing data interfaces. Web services application adapters translate between application-specific messages and FoS-specified XML messages for conveyance to other application adapters using the SOAP protocol. The web services integration server provides centralized control over message routing and can transform messages into new messages to accommodate changes in system components. The achieved interoperability allows the LM Team's solution to use COTS software and hardware to communicate with response organizations and military headquarters for responder control and situation reporting. The report server generates directives and reports in TTP-defined layouts. The communications server routes the reports and directives to the intended recipients as voice and text using TTP-defined communications avenues. Web services integration confines communications upgrade impacts to mediation rules and message routing changes.

A.3 CRRN Decision Support Tools

3.1 DSS Operation

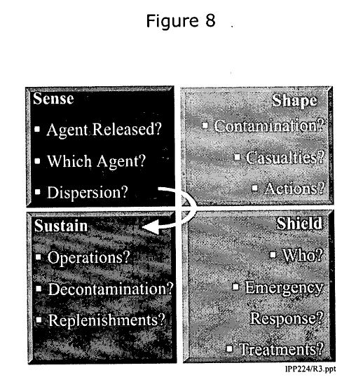

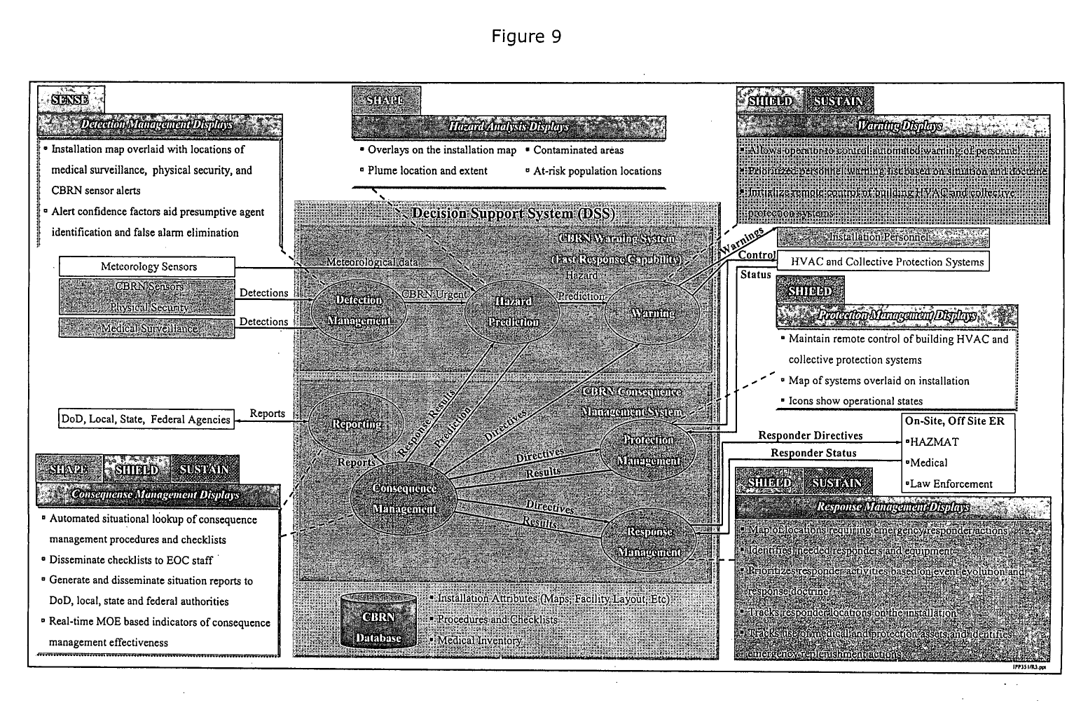

Installation protection effectiveness depends on making key CBRN event decisions, shown in FIG. 8, rapidly and accurately. The Fast Response Subsystem of our DSS, highlighted in FIG. 9, allows protective actions to begin during the opening minutes of an event even as the EOC becomes fully staffed to handle the event. This subsystem guides the on-duty EOC staff in confirming CBRN event occurrences, identifying at-risk personnel, issuing warnings and protection directives, and initiating unobtrusive protective actions such as reconfiguring building HVAC systems. Thus the at-risk population is simultaneously afforded maximum warning time and minimum shelter-in-place achievement time.

The DSS uses the sensed event characteristics and the TTP-derived decision rules described in paragraph 3.2 to provide the appropriate consequent management procedures and checklists to the EOC staff. The command staff uses annotated graphical displays of sensor states, plume extent, and locations of people at-risk (especially mission-critical personnel) to assess the situation, and then applies the DSS tool to generate prioritized lists of responder and protective actions to maximize personnel protection. Our DSS displays consequence management effectiveness in terms of the JPMG IPP MOEs, continuously updated using science-based IPP effectiveness models derived from Innovative Emergency Management's D2-Puff™ tool set. The D2-Puff™ tool set already provides consequence management decision support at four CSEPP installations.

3.2 Decision Rule Derivation

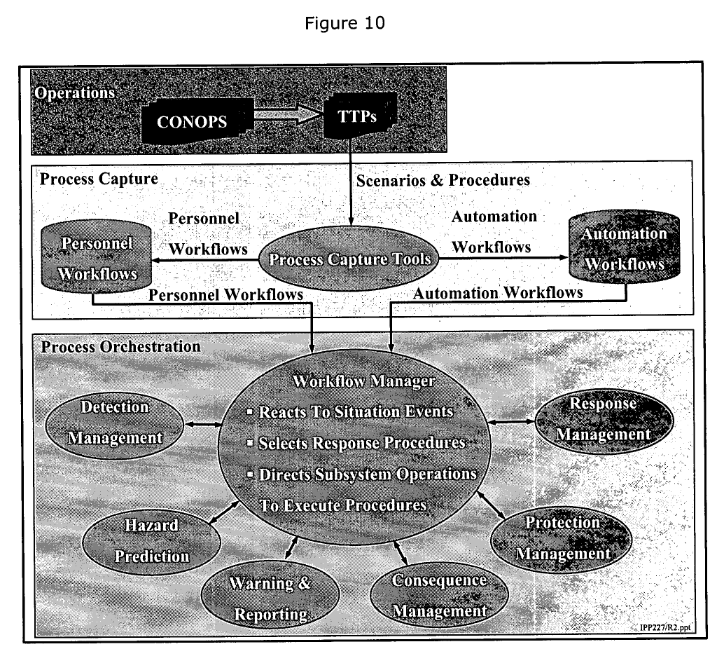

The workflow automation approach to decision support enhances installation protection by ensuring correct and timely initiation of protective actions prescribed in the CBRN consequence management TTPs. The human readable TTPs are translated into computer readable workflows as shown in FIG. 10 using COTS process capture tools such as IBM's WebSphere. The workflows identify CBRN event trigger conditions for IPP system and EOC staff actions. A COTS workflow manager uses the workflows to interpret CBRN event data and orchestrate the operations of the DSS subsystems which in turn guide the EOC staff activities.

A.4 MOE Computations

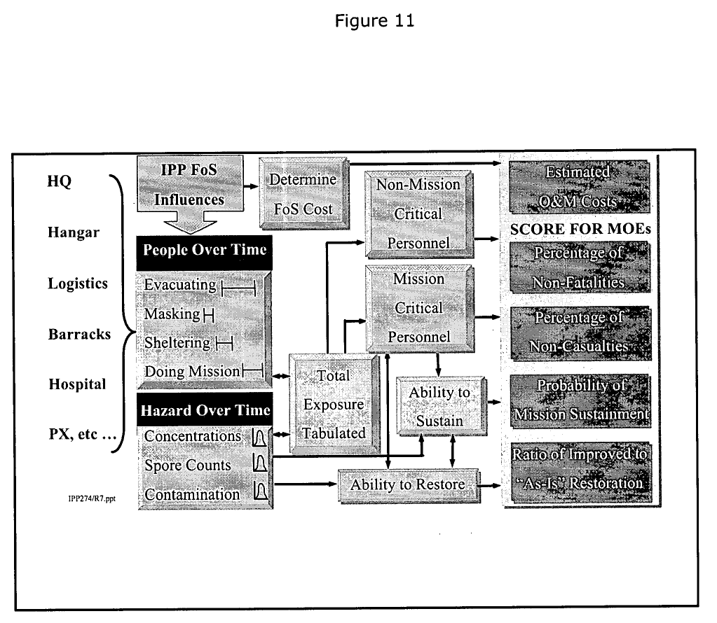

Our MOEs score protection on the IPP-specific dimensions of personnel, mission and cost. We capture the specifics of the installation layout, accommodate external variables such as weather, and differentiate details such as the relative level of protection provided by structures. Our tools track and interrelate hundreds of variables depending on the level of complexity required to generate a meaningful MOE value. FIG. 11 shows a number of these interacting variables and our process for calculating MOEs.

We determine the percent personnel protected by tracking the location and actions of the installation population in response to a number of CBRN attack scenarios. We tabulate exposures above a specific level as casualties for mission critical personnel and fatalities for non-mission critical personnel. We use medical treatment models, one of the “ability to restore” considerations in FIG. 11, to determine additional casualty or fatality adjustments.

We then determine the probability of mission sustainment over a pre-defined time period. We determine installation mission impact based on the loss of mission critical personnel or equipment, and the denial of critical resources based on contamination.

We calculate restoration time improvement based on the time it will take to restore essential functions.

Different IPP FoS solutions impact the variables and the MOE scores accordingly. We calculate associated FoS O&M cost as the final measure to inform solution alternatives and allow direct comparison. The focus of the O&M calculation is one year of sustainment for the FoS solution. Our O&M calculations iterate with the FoS solutions to ensure assumptions are consistent.

A.5 CBRN Technological Advancements

We base our IPP technology advancement structure and approach on the Rapid COTS Insertion (RCI) approach, adopted by the U.S. Navy to achieve significant capability improvements within limited budgets. Our approach embodies a capabilities (vs. requirements) based business model to acquire, integrate, test and field “best-of-breed” technologies to rapidly evolve capabilities to meet IPP objectives. Our RCI has demonstrated 2:1 reductions in development time compared to traditional “Mil-Spec” approaches, plus significant savings in development, acquisition and support costs. RCI axioms directly applicable to the IPP are:
Avoid modifying existing products;
Use State-of-Practice, not State-of-Art;
Configuration Management, not Configuration Control, allows flexible evolution;
Leverage innovation from Government and private labs, businesses, and universities.

Our team can rapidly upgrade IPP FoS capabilities using integration and testing of advanced, proven CBRN technologies to meet overarching IPP program objectives. We sponsor and invest in a consortium of Government laboratories, industry and universities to facilitate the refinement and insertion of new technologies. We propose a bottoms-up, data-driven, peer review process to critically assess new products and capabilities, test and integrate them carefully, and introduce improved capabilities at six- to twelve-month intervals.

We employ this dynamic, adaptable process, to sustain competition in an environment of rapidly evolving threats and capabilities. Our open architecture, capabilities-driven process and prototype testing in the SIL all combine to facilitate rapid modernization. Our approach allows parallel developments within different organizations, using their own tools and funding, to converge and integrate into a common FoS environment. We involve experienced users early in the process to develop the concepts and techniques to interact with new products and capabilities.

Some needed IPP CBRN capabilities include: (1) low false-alarm rate, biological detect-to-warn sensors; (2) a low intrusiveness, symptom-based medical surveillance capability to enable early identification and treatment; and (3) low-cost chemical sensors having complementary sensing technologies to minimize false alarms.

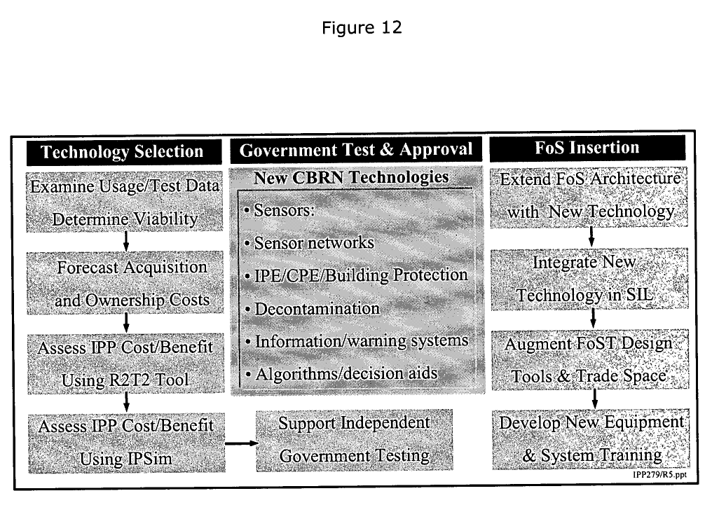

In FIG. 12, we show our technology insertion process for technologies requiring JPMG approval for addition to the equipment list. We use our RCI Rapid Response Technology Tradeoff (R2T2) planning tool and M&S performance and cost assessment to conduct IPP cost/benefits analyses to support the approval process. Technology developers provide usage and test data to support Government approval. Following approval, CBRN subject matter experts and experienced users participate directly in the rapid-prototyping and integration process in our SIL. We fine-tune the prototypes using a series of tests, integrated into the open, extensible FoS architecture and systems, and incorporated into the FoST process for evaluation as new or retrofitted installation designs. In addition, we use the SIL as a testbed to develop or augment packages for new technology training.

B.1.0 Sample TD Solution

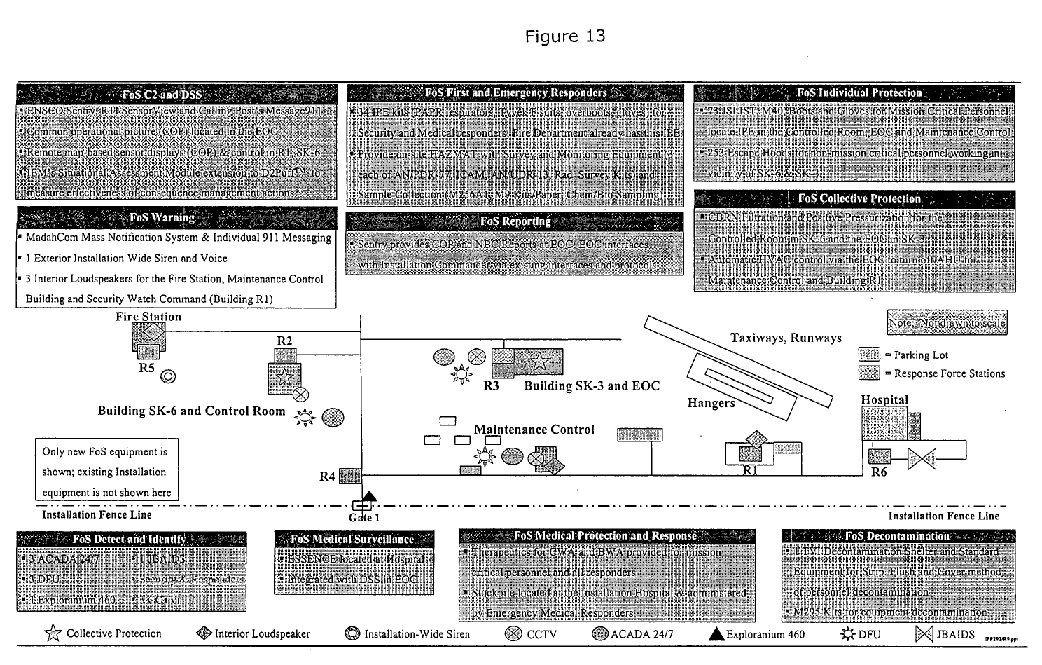

Beginning with the partial solution, the ISA performance requirements, and the approved list of CBRN equipment, we applied our subject matter expertise and Family of System Tradeoff (FOST) process to produce our FoS solution. Since a Sample TD cost target was not provided by the Government, we established a target for acquisition cost. Our FoS solution optimizes our five MOEs using Cost as an Independent Variable (CAIV). Using our simulation-based design methodology and tools, we performed iterations that optimized cost and performance against the MOEs to arrive at our solution, depicted in FIG. 13. We tailored our common IPP architecture to the Sample TD installation's mission and threats. Selecting the optimal combination of FoS components and integrating them with DOTMLPF factors into the existing C4I, emergency responder and physical security infrastructure, achieves our joint IPP goals.

To ensure an effective, low risk solution, we used only the Government approved CBRN COTS and GOTS equipment provided in the ISA. Deviating from this approved list would introduce unacceptable program and technical risk and would violate the JPMG SOW requirement of authorizing the use of any COTS before insertion in the IPP.

Our solution is not bound to the four threats provided. We changed CBR agents, release quantities and locations, and weather to ensure our solution and methodology provided effective protection and consistent results.

We made the assumptions listed below, in addition to those provided in the Sample TD, to produce an accurate quantifiable comparison of solutions, using the MOEs:
3 mission critical areas to protect: SK-3, SK-6 and maintenance control (MC)
Attacks focused on mission critical areas
73 mission critical personnel across all shifts; 7 in SK-3, 54 in SK-6, 12 in MC
The EOC in SK-3 is staffed 24/7
Civilian population distributed around clusters of buildings on the installation NIPRNET access in SK-6,SK-3,R1,MC

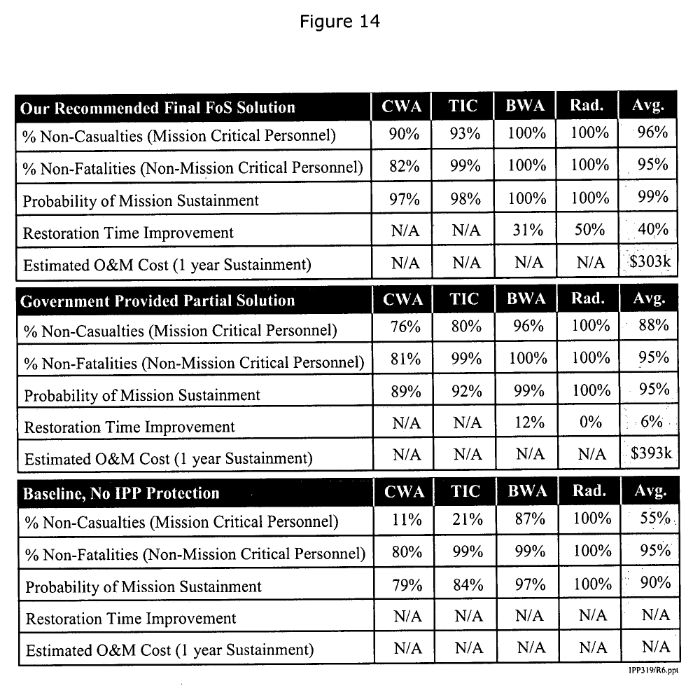

Our solution significantly improves upon the partial solution, especially for the percentage of non-casualties and mission sustainment with the CWA and TIC scenarios, as depicted in FIG. 14. Since the partial solution did not address decontamination, we computed a large restoration time improvement for attack scenarios requiring restoration. CONOPS and procedure changes account for the reduction in the estimated O&M costs for our solution. We established a reference for comparison between solutions, by computing the MOEs for a baseline, no protection set of scenarios.

We meet our other goals: an achievable schedule (we assumed the Sample TD was the 100^{th} installation); an affordable labor mix; and mitigation plans for the key technical risks.

B1.1 Overall Family of Systems (FoS) Effectiveness

1.1 Critical Mission Preservation and Restoration Effectiveness

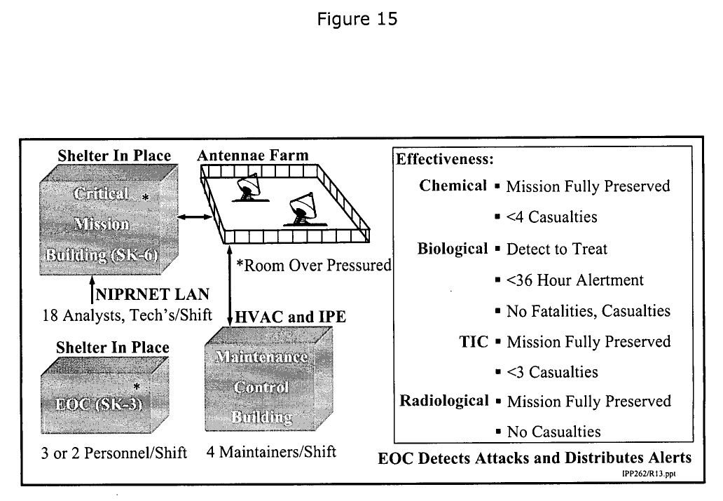

We preserve the critical mission using continuously controlled critical rooms, shown in FIG. 15, for collective protection in SK-3 and SK-6. These rooms are over-pressurized with filtered, make-up air. Sensors detect and identify the release of agents, and the EOC issues warnings for individuals to seek protection. Antennae maintainers don individual protection equipment (IPE) kept in the Maintenance Control Building. Warning lights alert personnel when it is unsafe to leave the building.

1.2 Response Forces Coordination, Training and Effectiveness

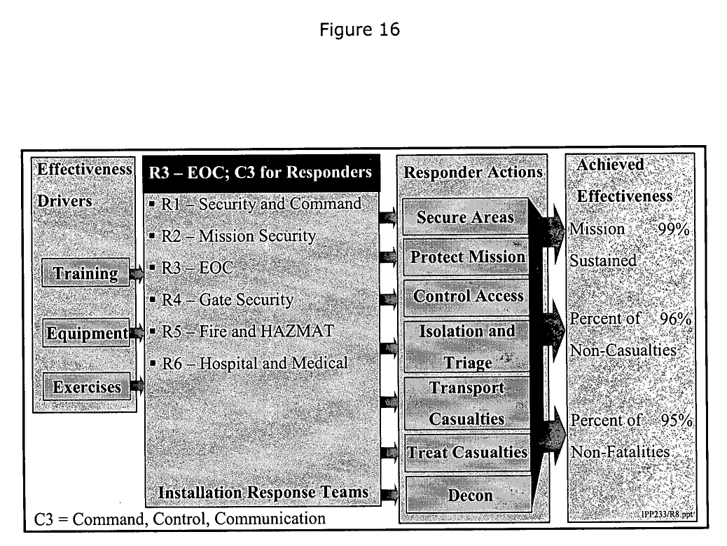

Our solution, shown in FIG. 16, uses the existing EOC installation infrastructure to command, control, coordinate and communicate with response forces and local support as well as communicate with Command. Use of the EOC minimizes the impact on the installation's CONOPS and procedures. Our Decision Support System (DSS) implements the Information Management System to pass all necessary information to the EOC and response forces so they bring the equipment and protection to address the event. We performed an early First and Emergency Responder evaluation and used it to identify needed equipment and training. Training gives immediate effectiveness improvement.

1.3 Four Scenarios; M&S and MOE Results

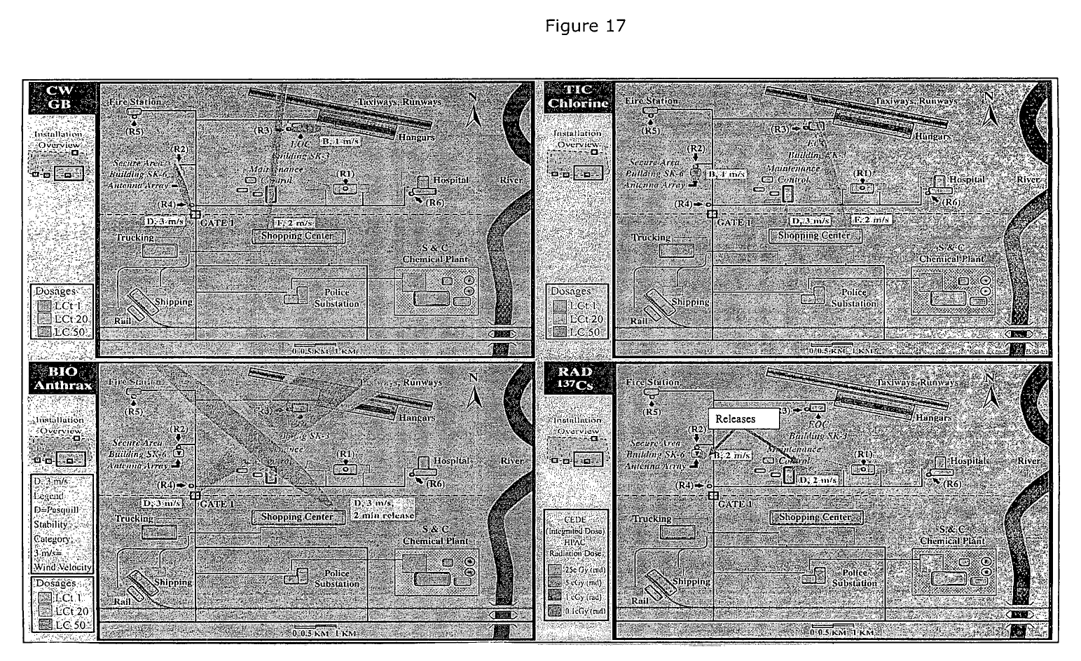

We used IPSim-Analysis, to evaluate our solution against the defined four threat scenarios and to support our FoST process. We ran the scenarios with over 250 release points under a variety of wind directions and diffusion rates. We used the terrorist targeting of mission critical population as a guide. FIG. 17 shows the four scenarios, with a subset of the release points, plumes and contaminated areas. The IP-Sim Analysis provides the numerical basis for the MOEs.

1.4 BWA Scenario Effectiveness

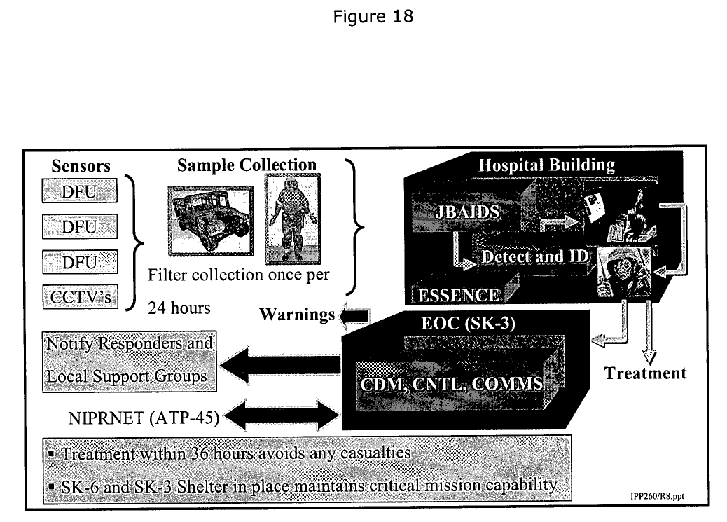

We based our FoS biological agent protection on a Detect-To-Treat approach. The FoS uses customer approved DFUs to continuously collect and concentrate air samples on a filter for 24 hours as shown in FIG. 18. These filters are collected manually and taken to a JBAIDS system at the installation hospital for analysis. The procedures for collecting, handling and preparing the filter contents for analysis are available from current DFU systems. The person making the DFU filter collections does a bag, tag and time-stamp process for forensics. The collector uses protective gear described in the procedures to avoid potential contamination. Our FoS CONOPS requires that the DFU sample filters be collected and analyzed once each day. This process detects and presumptively identifies biological agents in less than 36 hours from the release (<24 hours sampling and <12 hours JBAIDS processing). As shown in FIG. 18, when the analysis indicates a biologic agent is present, EOC is notified and response forces are alerted. Our FoS MOE for this scenario is 100% avoided mission casualties and sustainment. Our FoS includes ESSENCE as a medical surveillance tool. The installation and cooperating local hospitals use ESSENCE, to identify unusual patterns of illness that could represent infection by an undetected BWA. The hospital notifies the EOC and they take appropriate response action.

1.5 CWA Scenario and TIC Scenario Effectiveness

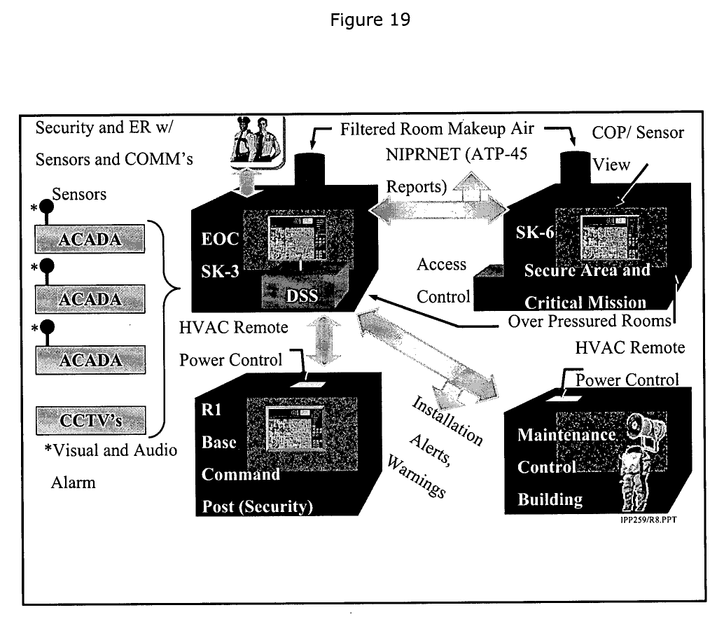

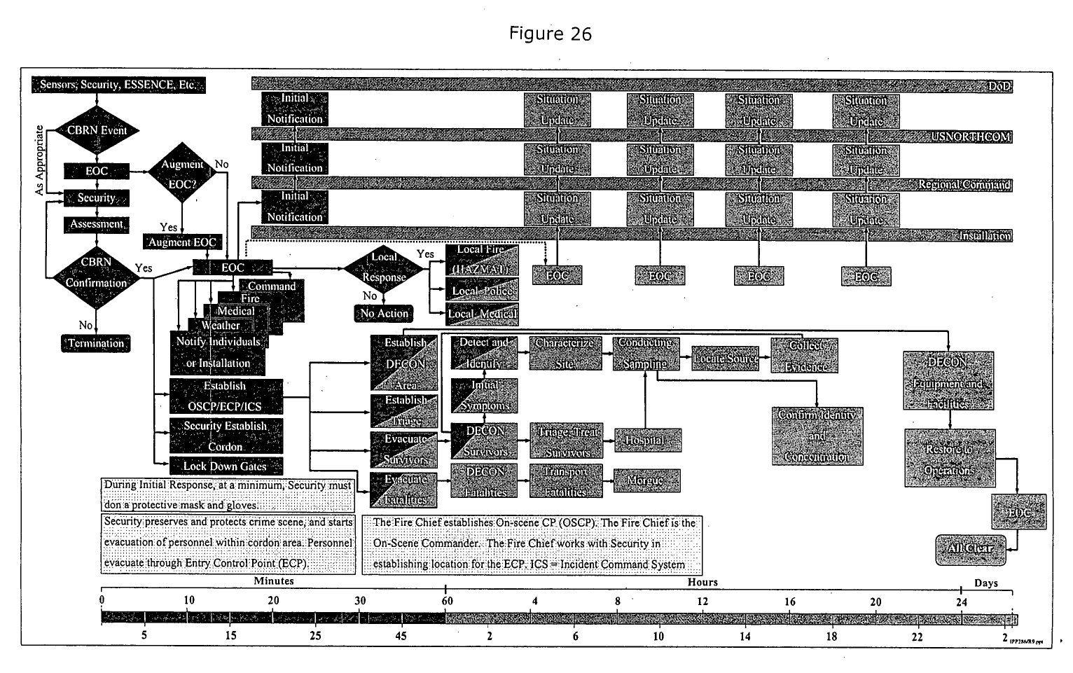

Our FoS uses Government-approved ACADA 24/7 chemical detectors to detect and presumptively identify the CWA or TIC. As shown in FIG. 19, the ACADA's are networked to the DSS. When an ACADA makes a detection report, the DSS provides processing to determine if this is a probable false alarm and presents the results on the Common Operating Picture (COP). EOC personnel or the Commander's representative make the final decision and permit DSS and the Warning and Reporting System to notify appropriate groups and initiate protections, such as powering off HVAC's. The protected buildings, SK-3 and SK-6, have over-pressured critical mission rooms with filtered make-up air for continuous protection against CWA and TIC. As shown in FIG. 26, other buildings normally offer sufficient protection time after warning (about 20 minutes) for the plume to pass or for personnel to don supplied IPE. When information permits, a tentative plume path is computed and shown on the COP. If the plume path is unknown, the EOC can alert all installation personnel. Personnel and dependents are warned to stay indoors with the HVAC off until the All Clear is sounded. Our MOE for CWA is 90%, TIC is 93%.

1.6 RAD-MAT Scenario Effectiveness

The radiological materials release often is prevented by our vehicle screening detector at Gate 1 or the hand-held detectors at Gates 2, 3 and 4. The radiological release contaminates a small area (FIG. 17). If it occurs within the installation, the Fire Department's HAZMAT team confirms it with their hand-held sensors, and cordons off the contaminated area.

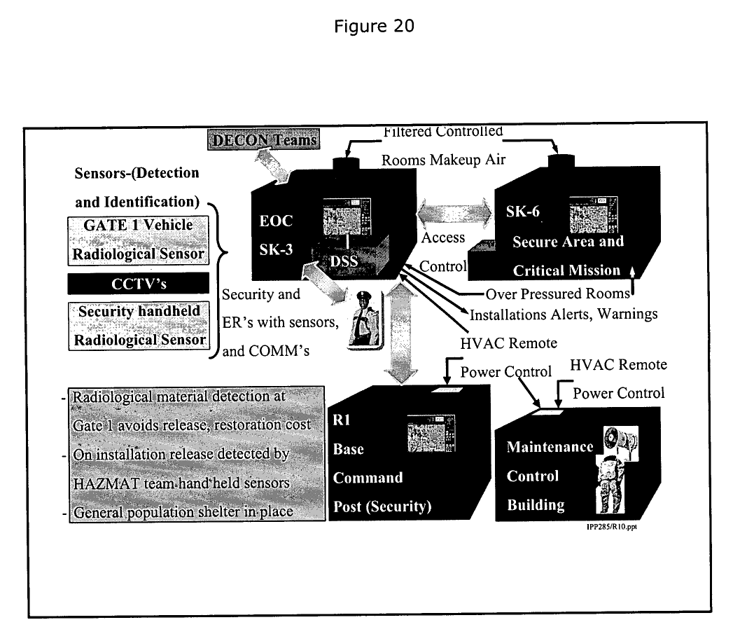

As shown in FIG. 20, mission critical personnel are protected by filtered air, over-pressured rooms except for the antennae maintenance personnel. They are protected by limiting their exposure time. They use IPE gear to prevent spreading the contamination. Since the planned maintenance requires only 60 to 90 minutes per shift and initial clean up (˜2 hours) is much less than the time between maintenance periods (8 hours), we avoid critical mission interruption. HAZMAT workers with decontamination equipment, and help as needed from off-installation, perform the decontamination and restoration effort. The installation HAZMAT team performs immediate decontamination using the training and equipment supplied. The radiological scenario MOE for our FoS is 100%, for no critical mission interruptions or casualties.

1.7 Alarm Assessment, Alarm Communication and Display System

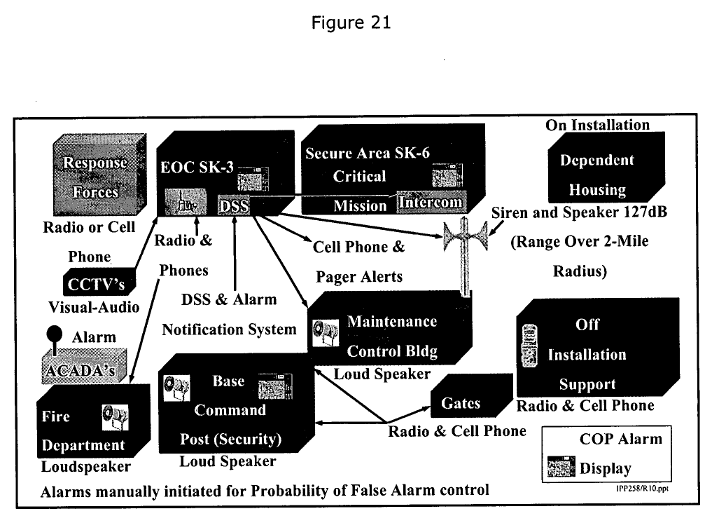

Our FoS completed the Warning and Reporting system of the Government's partial solution. Our mass and personal notification alarm and all-clear system gives the installation the flexibility to alert selected on- or off-installation persons or groups and provides a siren and loudspeaker system that reaches the entire installation as shown in FIG. 21. The selected individual, mission critical personnel and response team communication is via cell phones, or pagers, if out of cell range. Loudspeakers and intercoms allow notification of selected buildings. The 127 db installation siren and speaker alarm can alert the entire installation with siren or recorded messages.

Alarm assessment starts with false alarm processing in the DSS. The EOC IPP operator initiates the alarm and All Clear notification, with the Installation Commander's approval, to minimize the impact of potential false alarms or premature All Clear. This supports our Sustainment MOE of 99%. Detections by the ACADA sensors present a local visual and audible alarm. The COP displays alarms for coordination. Strobe lights on SK-3, SK-6, Maintenance Control and R1 Installation Command buildings alert personnel not to enter or exit the building.

1.8 DSS and CONOPS Effectiveness

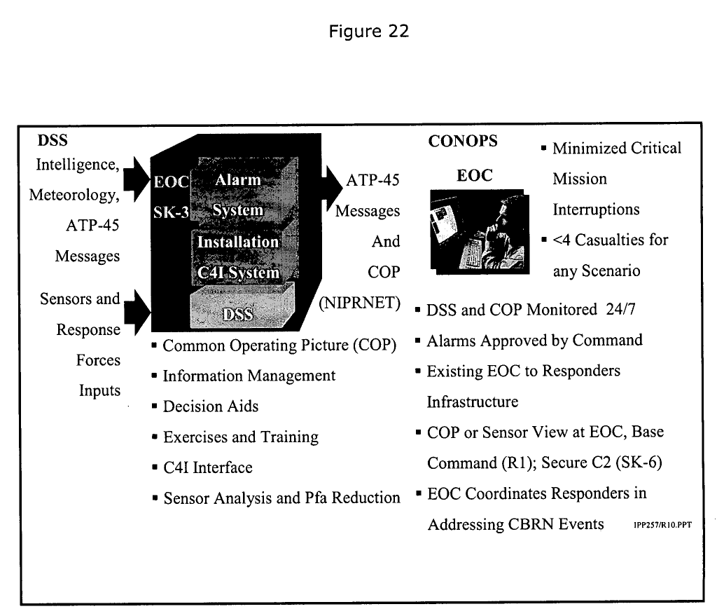

Our FoS uses the Sentry DSS, which is approved by the customer and proven in systems such as the Pentagon CBRN system. The DSS is a key element in our Information Management System. Sentry is a complete DSS, from sensor data collection, analysis, and event characterization to information dissemination and response. The DSS, in FIG. 22, analyzes and fuses disparate sensor information into an event by turning data into actionable information. This reduces the time for response to a CBRN release. Three operator skill levels, security, analyst, and administrator are supported. Sentry's integration capability reduces false alarms, enhancing our FoS effectiveness. DSS uses and produces NBC messages to support the reporting function. Our FoS CONOPS, as shown in FIG. 22, is developed in conjunction with the Installation Command. It interfaces with the existing installation infrastructure where possible, including Command, response force and off installation support communication and coordination. This minimizes changes in the installations operations and personnel requirements and reduces the estimated O&M costs. Our FoS CONOPS has the flexibility to allow tailoring and revisions by the Installation Command to improve the FoS effectiveness.

1.9 Science Based Principles Supporting the Final Design

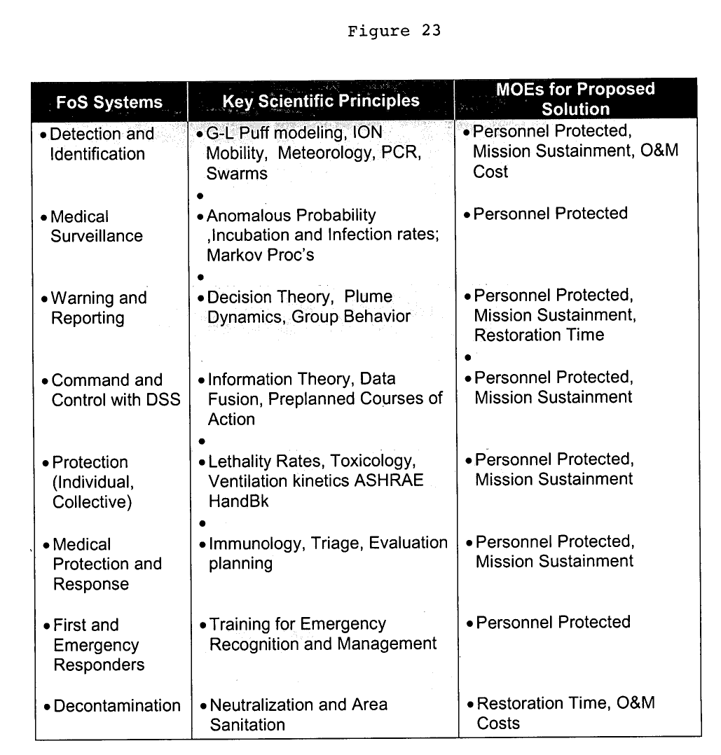

We base our FoS solution on the FOST process applied to the Sample TD installation. FOST uses trade-off's of quantified MOEs to select suitable, cost effective FoS solutions with the required performance. This requires science-based principles as listed in FIG. 23, both in the systems selected, such as sensor requirements for concentrators and minimum detection levels, and in the protection provided, including agent concentration-time dosages that produce illness or death. DSS uses both information processing and management science. In addition to using science based principles for the modeling and simulation (M&S) tools used in constructing our MOEs, we also make extensive use of M&S science to assure that the solution properly applies the scientific principles and achieves the required effectiveness. This is seen in the M&S evaluations of our FoS performance against the four provided scenarios. Fluid dynamics (D2-Puff™ software) is used to estimate plumes and areas of contamination. Ventilation kinetics estimates agent concentrations over time within un-pressurized buildings. We use Concentration and Time tables to estimate casualties. M&S validates FoS elements and computes MOEs.

1.10 Performance Measures and Response Times

We defined Measures of Effectiveness (MOE) and Measures of Performance (MOP) to quantify the effectiveness of our FoS solution and to support our TD solution process. MOEs quantify the utility of the system in the intended application. MOPs quantify the ability of the system to meet a design parameter.

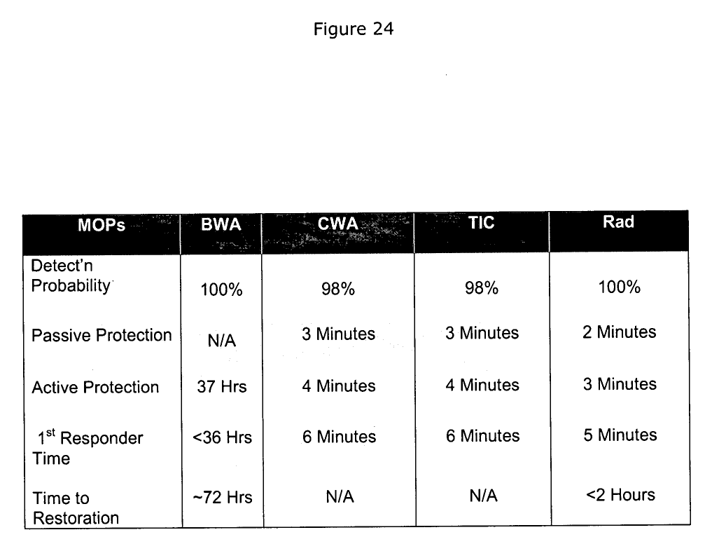

We developed the FOST process to provide the capability to respond quickly to Technical Directives with FoS solutions that meet constraints and requirements and are optimized for their effectiveness. This trade-off based optimization process requires that we can quantify the major system-level MOEs. We compute the required MOEs by applying our team's IPSim-Analysis tools. IPSim-Analysis tools allow us to optimize the locations of the sensors and collective protection rooms in buildings based on the expected target of the terrorists and the probable release locations, as defined in the Installation Vulnerability Report. The M&S tools use the sensor locations and probable release locations to compute the Probability of Detection. The installation map, responder training, and warning and reporting system are used to estimate response force arrival time. FIG. 14 lists the MOEs and FIG. 24 summarizes critical response times for our final FoS solution.

MOEs provide the quantification of complex capabilities needed for the Installation Protection Program. Quantification allows comparisons and tradeoffs of systems and solutions, moving the design of the IPP FoS from art to engineering.

B1.2 Operational Analysis

Our FOST process utilizes IPSim-Analysis tools and performance-based MOEs in operational analysis to quantify improvement and validate event-based decision processes.

2.1 Operational Analysis of Sample TD Solution

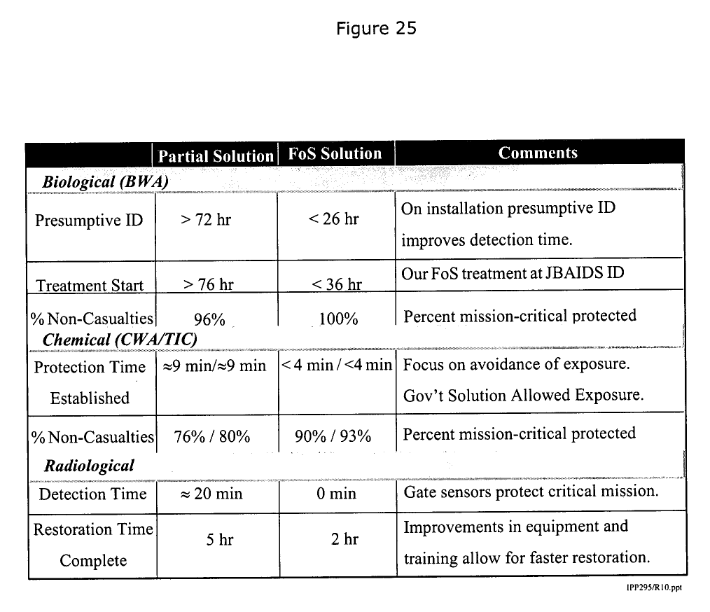

Our operational analysis identifies key events that take place in each attack scenario. Events were analyzed for process deficiencies and drivers. We utilize modeling and simulation tools (IPSim-Analysis) to generate MOEs, based on certain MOPs, such as sensor response time or treatment time. These MOEs quantitatively compare different IPP processes in order to select the most effective solution within the constraints. For this Sample TD Solution, our FOST process generated a solution that predicts fewer mission critical casualties and a greater probability of mission sustainment while demonstrating that additional expenditures would not significantly improve the effectiveness. FIG. 25 summarizes key critical IPP process times from the OV-6c sequence diagrams and demonstrates that our final FoS solution shows improved effectiveness over the government's partial solution for the four attack scenarios.

2.2 BWA (Anthrax)

Our final FoS solution adds an on-installation JBAIDS to presumptively identify biological agents more quickly, allowing treatment to begin earlier and improving mission sustainment. Earlier detection allows treatment for mission critical and installation personnel within the 72 hour critical time window for Anthrax. Our analysis predicts 100% probability of mission sustainment for our solution.

2.3 Chemical (CWA and TIC)

The ACADA sensors, with the ENSCO Sentry based DSS and our Warning and Reporting system provide active antennae maintainers with sufficient notification to don supplied IPE. The Maintenance Control building, with HVAC off, provides over 20 minutes of protection before effects are significant. Also with provided masks, active antennae maintainers could proceed immediately to the collective protection of SK-6, minimizing exposure. ATP-45 modeling narrows the area requiring warning by projecting the path of the chemical plume. The CWA and TIC releases result in a similar sequence of events. There is a small difference in the percentage of mission critical personnel protected (non-casualties) as a result of the different chemical properties.

2.4 Radiological (Cesium-137)

The Exploranium-460 scans vehicles entering Gate 1, preventing entry of radioactive material and protecting the mission. For the scenarios analyzed, both the explosive charge and the amount of radioactive material provided in the scenario are too small for outdoor releases to significantly impact the mission, thus most initial and final solution MOEs are the same. A larger release would show a larger difference. We benefit from a short restoration time based on enhanced training and equipment. The Exploranium-460 was placed at Gate 1 only, optimizing the solution for cost while still providing sufficient protection. Visitor and truck traffic pass primarily through Gate 1, making this the primary area needing protection. Other gates (2, 3 and 4), generally used by installation personnel, hold less risk. Random inspections, at these other gates, with portable sensors provide added protection.

B1.3 Operational Integration of the Family of Systems

our FoS solution integrates smoothly into the existing installation's infrastructure by building on existing CONOPS, procedures, organization and MOUs to maximize protection, sustain the mission and restore operations.

3.1 Installation Process Review

Our operational integration approach assesses current installation operations to gauge the best way to leverage the installation's existing capabilities. Our recommended final FoS solution updates the CBRN CONOPS by integrating into the existing critical mission, C4I, physical security, and emergency responder infrastructure, augmenting, but not disrupting, current procedures.

Our IPP CONOPS decision tree, shown in FIG. 26, uses the installation's existing physical and operational infrastructure, plus local community capabilities, to provide our final FoS solution. The decision tree identifies key actions based on a critical time line.

3.2 Command and Control

In our final FoS solution, the EOC in SK-3 continues as the primary decision and communications center for all events, including CBRN, on the installation. We also supply the EOC with additional control and monitoring capabilities, including sensors, a DSS with a COP, and a web-based CCTV system. These capabilities leverage the existing installation's communications NIPRNET infrastructure to transmit data and video. Our IPP operators are the current EOC personnel who continue to interface with the installation commander, responders, supporting organizations, and higher echelons, employing existing CONOPS, phone and radio communications.

Security, in building R1, is the installation's secondary decision center for all events, including CBRN. Our FoS solution provides the security center with the CBRN COP so Security can support the EOC during all hours.

Our recommended medical surveillance FoS component, ESSENCE, which can detect covert biological releases, is located at the installation's hospital. We integrate ESSENCE into the DSS within the EOC. Coordination with the local hospital is accomplished via existing mechanisms and MOUs.

3.3 Physical Security

Our FoS solution augments the existing physical security infrastructure of the installation without disrupting the current CBRN response CONOPS described in the Sample TD. To support our detect-to-prevent strategy for radiological threats, we added an Exploranium-460 sensor at gate 1 to increase the probability of detection outside the mission critical areas. Also, we supplied portable radiation detectors for security personnel to use at other gates during random inspections and upgraded threat conditions. MOAs exist with local and state law enforcement to augment installation personnel or equipment requirements.

3.4 First and Emergency Responders

Our solution recognizes that the installation's fire department has HAZMAT gear, procedures, and training in HAZMAT removal and decontamination. To enable the HAZMAT team to quickly restore mission essential operations after a CBRN event, we added decontamination equipment and training. Our solution also provides survey, monitoring and sample collection equipment to support consequence management. Should additional support be required, MOAs exist with the off-site fire department to provide it. Medical responders continue to use the existing CONOPS to establish the triage area, provide life saving treatment, isolate contaminated personnel and transport casualties to the hospital. Our final FoS solution adds BWA and CWA therapeutics for mission-critical personnel and responders to sustain the critical mission.

3.5 Integration with the Community

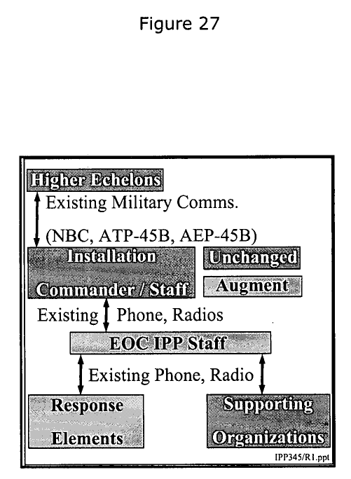

Integrating the community's capabilities into our FoS solution is vital for protection of the installation. Such integration provides cost savings to both the installation and the local community by avoiding duplication of capabilities. Our solution anticipates that local support may be required, and is available through existing MOUs. FIG. 27 shows the extent of existing capabilities leveraged by our FoS solution.

B1.4 Technical Selection of FoS Components

4.1 FoS Selection Methodology

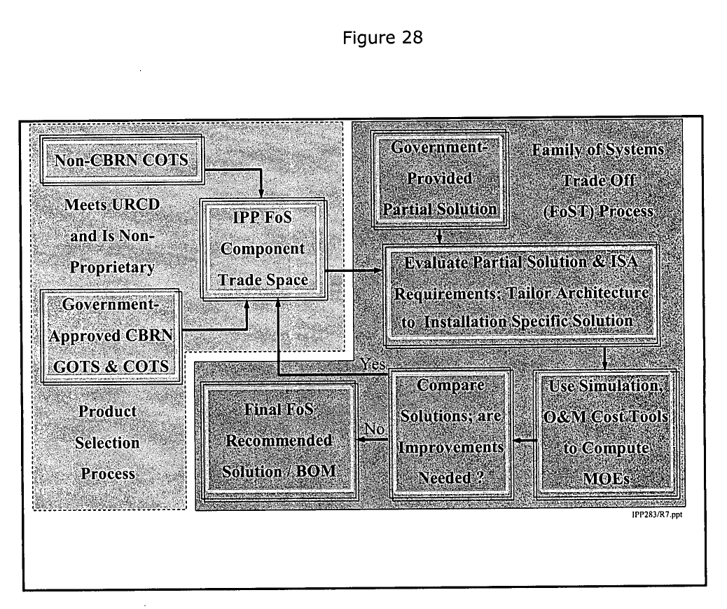

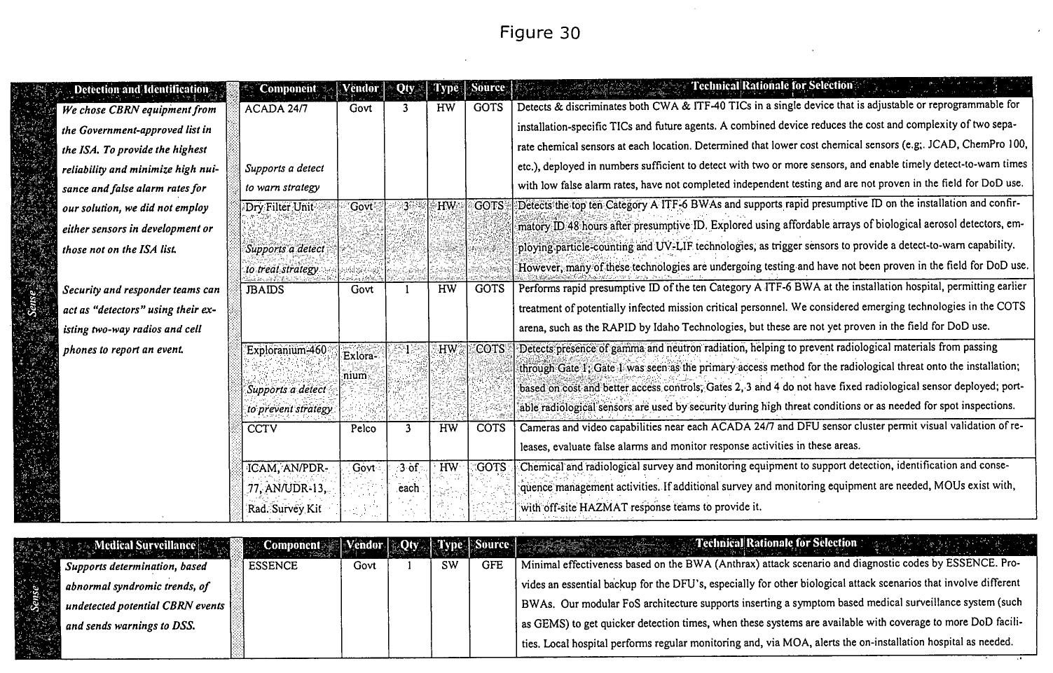

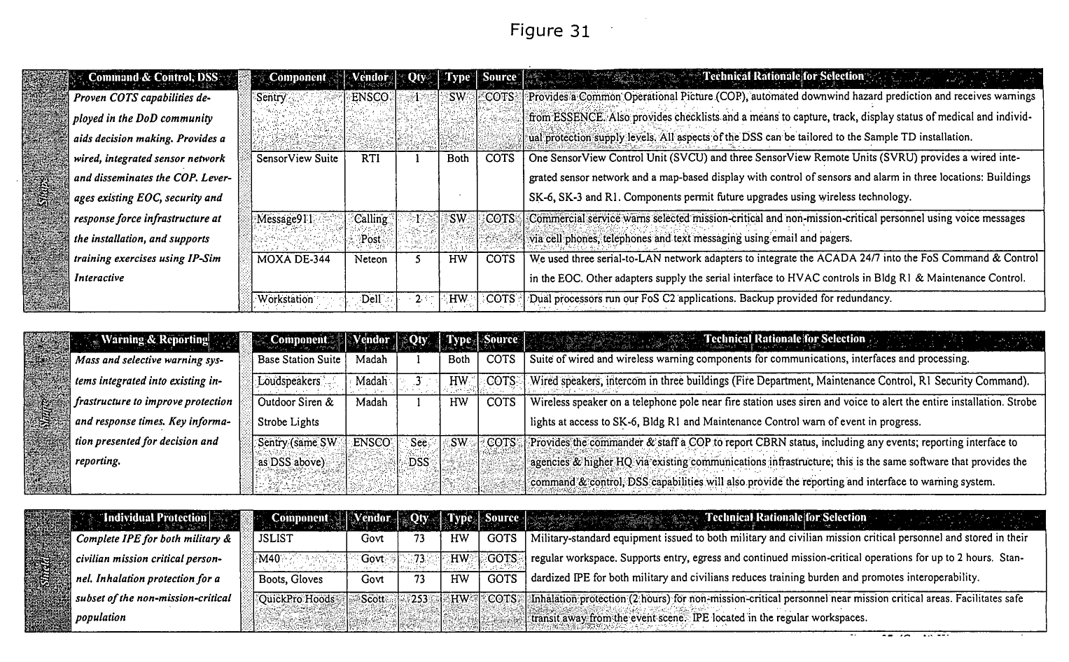

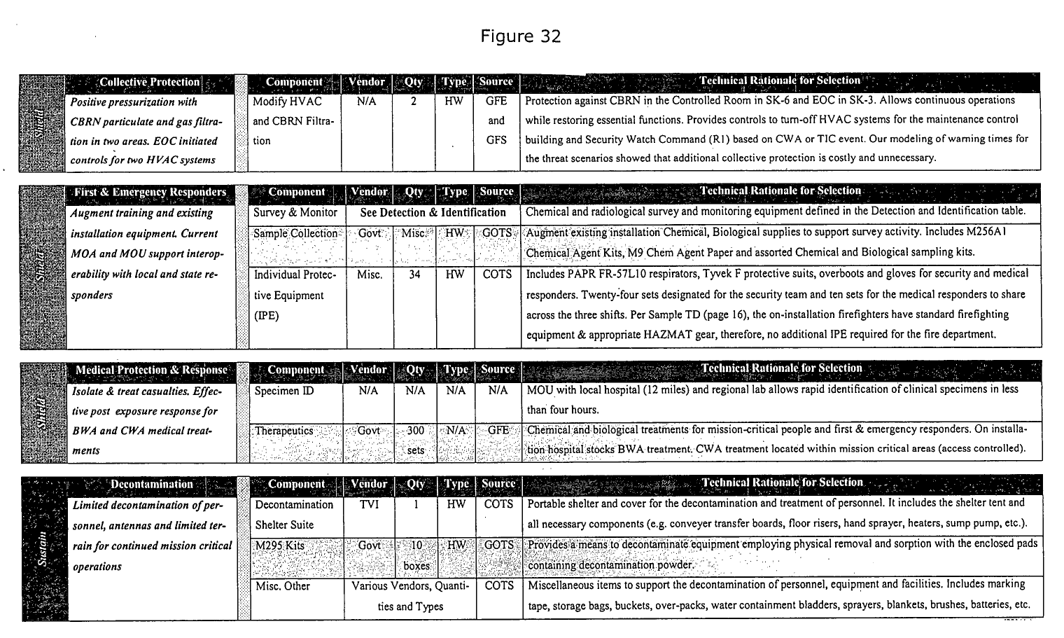

Our solution meets ISA performance requirements and provides the maximum protection, response and restoration for minimum cost and risk. We applied proven processes to select the best FoS components and integrated them into an optimal solution. Our product selection process, as shown in FIG. 28, filtered out CBRN equipment that is not government approved, is proprietary or does not meet the IPP URCD. Next, we used our FoST process to define and evaluate (via the MOEs) our final FoS solution. FIGS. 30-32 provides the high level Bill of Material and the rationale for selecting each FoS Component.

4.2 Sensor Selection and Location

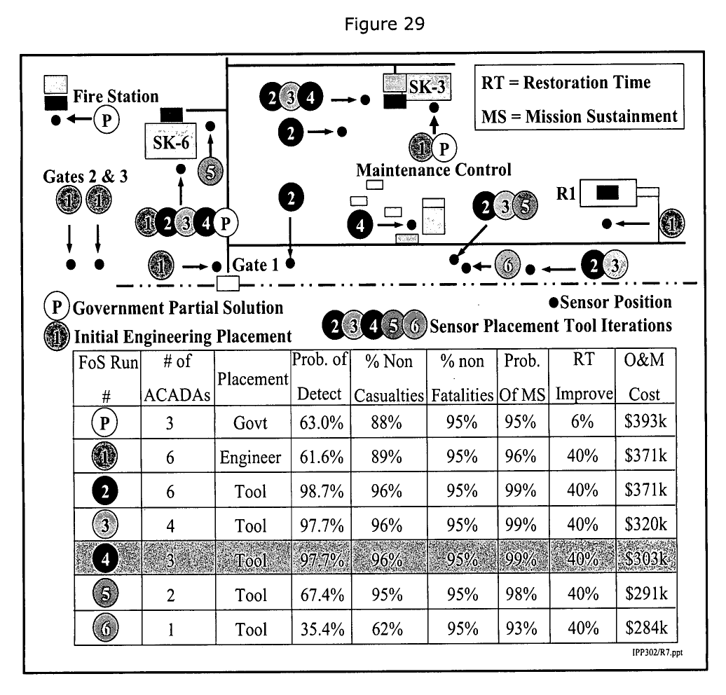

Using our IP-Sim Analysis sensor placement tool, we chose the quantity and placement of the ACADAs to maximize the MOEs and the probability of detection (FIG. 29). Our solution contains three ACADAs. The two ACADA option causes a slight reduction in the percentage of non-casualties. Adding the third sensor near SK-3, for minimal cost, prevents the loss of mission critical personnel at the EOC. This ensures the EOC warning and responder coordination capability is unaffected. We chose 3 DFUs to provide full coverage for each mission critical area. Our solution minimizes fielding cost by locating them next to each ACADA. The benefits of our methodology increase when used for other types of sensors, including biological and radiological, and for larger installations with more mission critical areas to protect.

B1.5 FOS System Design

5.1 C4I Design

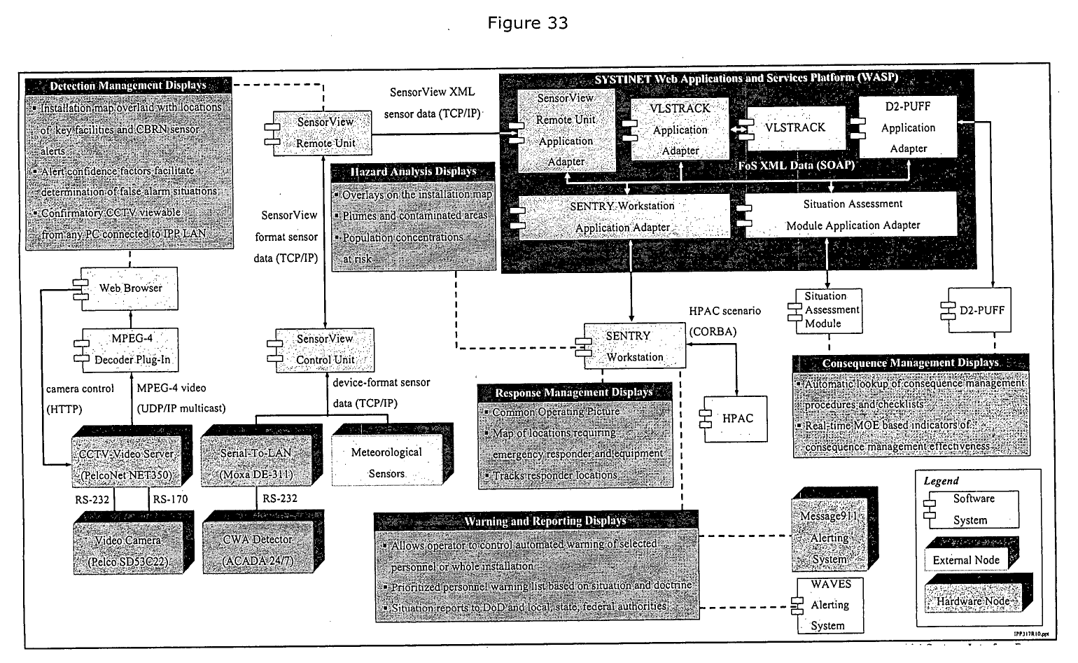

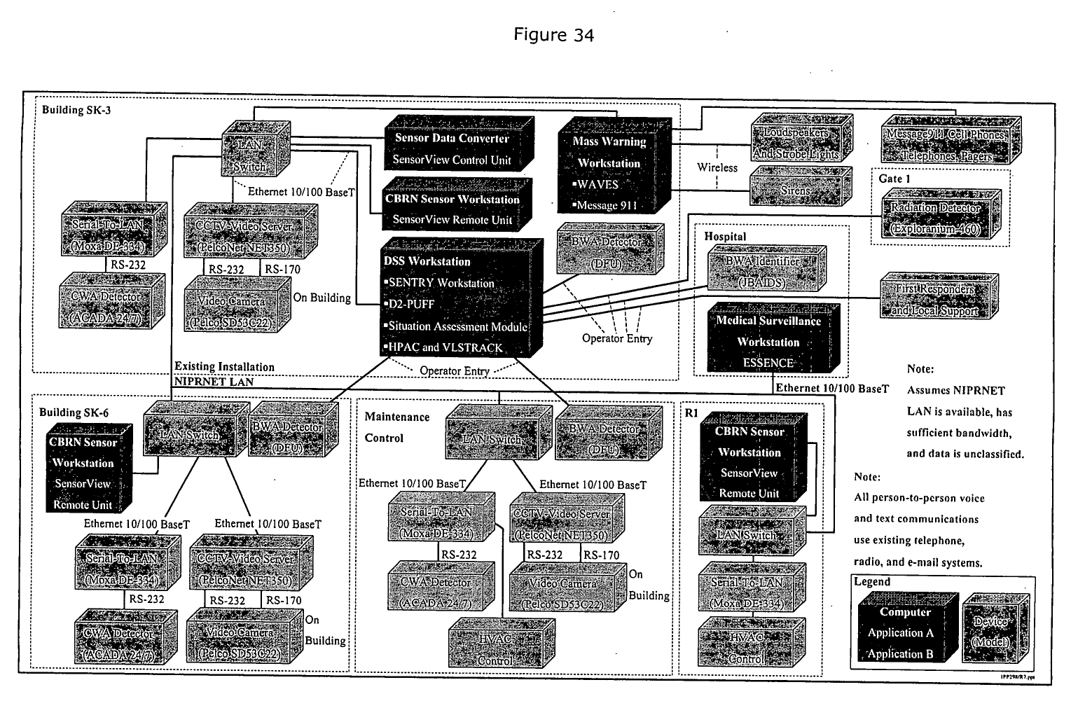

Our system design DoD-AF SV-1 view, as shown in FIG. 33, illustrates our ability to provide an effective integrated final FoS solution. The DSS uses ENSCO's SENTRY Workstation to provide an in-depth Common Operating Picture (COP) to support EOC personnel in detecting events, assessing hazards, managing responders, and assessing event consequences. SENTRY accesses HPAC and VLSTRACK plume models and uses event rules to automatically interact with IEM's D2-Puff™ and Situation Assessment Module (SAM) extension. D2-Puff™ generates hazard assessment and protective action recommendations to minimize casualties. The SAM uses sensor and responder status and surveys to continuously provide indications of the consequence management effectiveness in terms of the MOEs. A key integration enabler is Systinet's Web Applications and Services Platform (WASP) that provides system interoperability using Web Services to achieve inter-system communications with little or no integration software development or existing software impact. The DOD-AF SV-2 physical data transport infrastructure (FIG. 34) ensures all data passed between systems are network messages, which Web Services can receive, manipulate, and transmit as necessary. Our solution exploits the sensor interface support (23 device types) provided by an RTI SensorView Control Unit (SVCU), which converts raw sensor data into a form for display by SensorView Remote Units (SVRUs). SVRUs provide map-based CBRN sensor situation displays to the EOC, security watch commander and the HQ C2 element. The EOC SVRU provides a sensor data stream in XML format to the SVRU Application Adapter (SVRUAA). The SVRUAA enforces data definitions for system-wide interoperability by converting the data to the FoS XML schema and then uses SOAP messages to publish the data to other subscribing application adapters.

The placement of device and systems data on the IPP LAN is a key enabler that allows Web Services to integrate our solution into the existing installation C4I systems (FIG. 34). Our FoS solution eliminated LAN wiring installation as a significant cost driver by using the installation's existing NIPRNET LAN for the IPP LAN. This allows the installation command to use the existing NIPRNET-based communication systems to communicate event situation (NBC ATP45) reports up the chain of command. Re-using the installation's NIPRNET wiring plan preserves the installation's communication security certification (unlike wireless networking) and leverages or upgrades the installation's IT infrastructure to support the IPP FoS. Sensors, loudspeakers and HVAC controls with serial interfaces connect to the LAN using four Moxa DE-344 Serial-To-Ethernet converters. Three Pelco NET350 video servers allow all consequence management personnel to use a web browser on their workstations to receive video concurrently and to control our solution's pan-tilt-zoom (PTZ) cameras for visual confirmation of an event. Our solution's network topology eliminates point-to-point connections between computers, sensors, and building control systems. This solution allows any computer to run any application, even those applications that directly use or produce these devices' data. This computer redundancy improves system availability.

5.2 C4I Integration Supporting Mission Continuity

Mission continuity depends on the preservation of mission critical personnel. Our solution integrates the FoS with the existing installation infrastructure to provide enhanced personnel warning, while maintaining existing responder control. To warn personnel, we augment the installation's existing phone and e-mail system with a public address (PA) system and a commercial telephone warning service. The PA system is Madah's Wireless Audio Visual Emergency System (WAVES), comprising a set of exterior wireless sirens, wired loudspeakers, intercoms, and the WAVES control software, which executes on the EOC's Mass Warning workstation. Message911 is the commercial service that warns selected personnel using voice messages via cell phones and telephones and text messages using pagers. We achieve responder control using the installation's existing telephones and radios. Due to the small installation size in the Sample TD, it is more cost effective to retain the installation's existing on-site and offsite communications procedures and equipment, instead of automating the communications system and revising the communications procedures and training.

B1.6 Mission Recovery and Restoration

Our final FoS solution combines standard civilian and military decontamination techniques to rapidly recover and restore the Sample TD installation's mission critical functions after a CBRN attack.

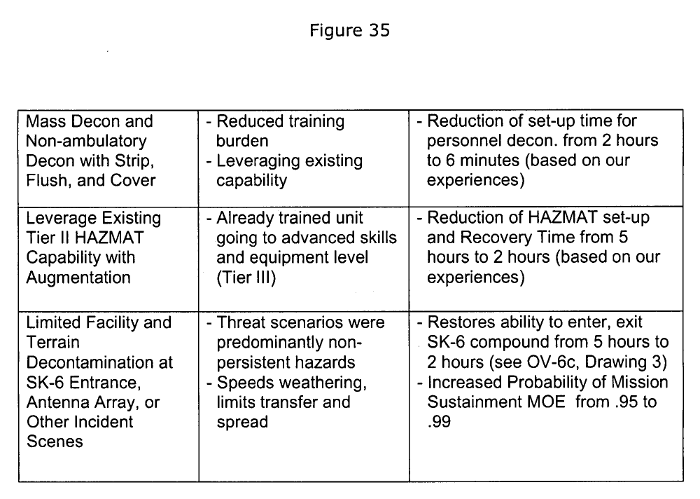

An integrated set of training and materials have been developed that are not only simpler, but use civilian-standard decontamination procedures. Using IPSim-Analysis, we measured the effectiveness of our FoS solution vs. the Government partial solution that had only limited decontamination capabilities. FIG. 35 illustrates the measured level of improvement and the performance benefits of our solution. Our final FoS solution significantly reduced equipment requirements and enabled faster recovery and restoration operations.

### C1 GLOSSARY OF ACRONYMS

ACRONYM Full Title

24/7 24 Hours per Day for 7 Days per Week
ABL As Built List
ACADA Automatic Chemical Agent Detector and Alarm
ACEIT Automated Cost Estimating Integrated Tools
ACS Aerial Common Sensor
ADS Advanced Deployable System
A&E Architecture and Engineering
AEGL Acute Exposure Guideline Level
AEP-45B Allied Publication-45B
AFB Air Force Base
AFCESA Air Force Civil Engineering Support Agency
   ACRONYM Full Title
AHU Air Handling Unit
AMBR Agent-based Modeling and Behavioral Representation
AMC Army Materiel Command
AMP Air Modernization Program
AN/UDR-13 A Radiac Meter
AN/USQ-78A P-3C Block Modification Upgrade
AN/UYS-1 Standard Signal Processing Program
Ao Operational Availability
AOC Air Operations Center
APB Advanced Processing Build
AR Army Regulation
ARCHR™ Architecture for Reuse
A-RCI Acoustic-Rapid COTS Insertion
ASAS All Source Analysis System
ASHRAE American Society of Heating, Refrigeration and Air Conditioning Engineers
ASOAR Achieving a System Operational Availability Requirement
ASP Application Service Provider
AT Anti-Terrorism
AT/FP Anti Terrorism/Force Protection
ATP-45 Allied Technical Publication-45B
B2B Business-to-Business
BCDS Biological Chemical Decontamination Systems
BIDS Biological Integrated Detector System
Bio Biologic
   ACRONYM Full Title
BOE Basis of Estimate
BOM Bill of Materials
BWA Biological Warfare Agent
C2 Command and Control
C2BMC Command and Control, Battle Management and Communications
C3I Command, Control, Communications and Intelligence
C4I Command, Control, Communications, Computers, and Intelligence
C4ISR Command, Control, Communications, Computers, Intelligence, Surveillance, Reconaissance
CAD Computer Automated Design
CAIV Cost As an Independent Variable
CAS Cost Accounting System
CASB-CMF Cost Accounting Standards Board—Cost of Money Factors
CAST 2000 COTS Assessment and Selection Technique, Version 2000
CB Chemical Biological
CBAWS Chemical Biological Aerosol Warning System
CB DAS™ Chemical Biological Dial-a-Sensor
CBR Chemical Biological Radiological
CBREWS Chemical Biological Radiological Early Warning System
CBRN Chemical, Biological, Radiological, and Nuclear
CC&DSS Command and Control and Decision Support System
CCTV Closed Circuit Television
CCY Contractor Calendar Year
CDC Centers for Disease Control and Prevention
CDP Center for Domestic Preparedness
   ACRONYM Full Title
CDRL Contract Data Requirement List
CECOM U.S. Army Communications-Electronics Command
CEE Collaborative Engineering Environment
CEO Chief Executive Officer
CFM Cubic Feet per Minute
CFO Chief Financial Officer
Chem Chemical
CLIN Contract Line Item Number
CLS Contractor Logistics Support
CM Configuration Management, or Corrective Maintenance
CMDR Commander
CMM Capability Maturity Model
CMMI Capability Maturity Model Integrated
CNO Chief of Naval Operations
COA Course Of Action
COAC Cadet Officer's Advanced Course
COBC Cadet Officer's Basic Course
COE Concept of Employment
COM Cost of Money
COMMS Communications
COMPASS Computerized Optimization Model for Predicting and Analyzing Support Structures
CONOPS Concept of Operations
CONUS Continental US
COP Common Operational Picture
   ACRONYM Full Title
CORBA Common Object Request Broker Architecture
Corr Corrective
COTR Contracting Officer's Technical Representative
COTS Commercial-Off-The-Shelf
CP Command Post
CP/IP Collective Protection/Individual Protection
CPD Capabilities Procurement Document
CPE Collective Protection Equipment
CPFF Cost Plus Fixed Fee
CPI Cost Performance Index
CPIF Cost Plus Incentive Fee
CRADA Cooperative Research and Development Agreement
CSC Customer Support Center
CSEPP Chemical Stockpile Emergency Preparedness Program
CT Cost Team
CWA Chemical Warfare Agent
CWBS Contract Work Breakdown Structure
CY Calendar Year
D2D Design to Disposal, LM Trademark
D2-Puff™ IEM company Downwind Hazard Prediction Modeling Program
DACO Divisional Administrative Contracting Officer
DARPA Defense Advanced Research Projects Agency
D&B Dunn & Bradstreet
DCAA Defense Contracting Audit Agency
   ACRONYM Full Title
DCMA Defense Contracting Management Agency
DECON Decontamination
DEP&S Detailed Equipment Plan and Schedule
DFU Dry Filter Unit
DLA Defense Logistics Agency
DLD Direct Labor Dollars
DLH Direct Labor Hours
DM Data Management
DMS Defense Messaging System
DoD Department of Defense
DOD-AF Department of Defense—Air Force
DoDI Department of Defense Instruction
DoE Department of Energy
DoJ Department of Justice
DOTLPF Doctrine, Organization, Training, Leadership, Personnel and Facilities
DOTMLPF Doctrine, Organization, Training, Materiel, Leadership, Personnel and Facilities
DPPH Direct Productive Person Hour
DPM Deputy Program Manager
DRI Digital Research, Inc.
DSS Decision Support System
DTA Design to Affordability
DTLOMS Doctrine, Training, Leadership Development, Organization, Materiel and Soldiers
DTRA Defense Threat Reduction Agency
   ACRONYM Full Title
DVATEX Disaster Preparedness Vulnerability Analysis Training and Exercise
DVD Direct Vendor Delivery
EAC Estimate At Complete
EBO Effects-Based Operations
ECBC Edgewood Chemical and Biological Center
ECP Entry Control Point
EDI Electronic Data Interchange
EFA Engineering Field Activity
EMIS Emergency Management Information System
EMS Emergency Medical Services
EN Evaluation Notice
ENSCO ENSCO Software-Company
EOC Emergency Operation Center
ER Emergency Room
ETC Estimate to Complete
EVM Earned Value Management
FAR Federal Acquisition Regulations
FedEx Registered Trademark of Federal Express
FEMA Federal Emergency Management Agency
FEMIS Federal Emergency Management Information System
FER Final Evaluation Report
FFP Firm Fixed Price
FFRDC Federally Funded Research and Development Center
FFX Fully Functional Exercise(s)
   ACRONYM Full Title
FM Field Manual
FMER Funds and ManHour Expenditure Report
FOIA Freedom of Information Act
FPIP Fixed Price Plus Incentive Fee
FPR Forward Pricing Rate
FPRA Forward Pricing Rate Agreement
FoS Family of Systems
FoST Family of Systems Tradeoffs
FOUO For Official Use Only
FTE Full-Time Equivalent
FY Fiscal Year
G&A General & Administrative
GCCS-A Global Command and Control System—Army
GEMS Global Expeditionary Medical System
GFE Government-Furnished Equipment
GFI Government-Furnished Information
GFM Government-Furnished Material
GFP Government-Furnished Property
GFS Government-Furnished Supplies
GIG-ES Global Information Grid Enterprise Services
GIST Guardian Integrated Support Team
G-L Gauesian-LaGrandian
GLC Government Labor Category
GMP Good Manufacturing Practices
   ACRONYM Full Title
GOTS Government-Off-The-Shelf
HAZMAT Hazardous Materials
HBCU Historically Black College and University
HFE Human Factors Engineering
HIIPS HUD Integrated Information Processing Services
HLA High Level Architecture
HPAC Hazard Prediction & Assessment Capability
HR Human Resources
HIS Human to System Interface
HQ Headquarters
HUBZone Historically Underutilized Business Zone
HUD Department of Housing and Urban Development
HVAC Heating, Ventilation and Air Conditioning
HW Hardware
IAW In Accordance With
IBM IBM Corporation
IBP Innovative Business Practice
ICAM Improved Chemical Agent Monitor
ICS Incident Command System
ID Identification
IDE Integrated Digital Environment
IDLH Immediately Dangerous to Life and Health
IEA Installation Exercise Assessment
IETM Interactive Electronic Technical Manual
   ACRONYM Full Title
I/F Interface
IGCE Independent Government Cost Estimate
ILS Integrated Logistics Support
IMP Integrated Master Plan
IMS Integrated Master Schedule
INNOLOG Innovative Logistics Techniques
I/O Input/Output
ION Ion (Ion-mobility spectroscopy)
IPE Individual Protection Equipment
IPE/CPE Individual Protection Equipment/Collective Protection Equipment
IPG Integrated Process Group
IPMA International Project Management Award
IPP Installation Protection Program/Industrial Preparedness Planning
IPSim Installation Protection Simulation
IPT Integrated Process Team
IR&D Independent Research & Development
ISA Initial Systems Architecture
ISO International Standards Organization
I&T Installation and Testing
JBAIDS Joint Biological Agent Identification System
JBPDS Joint Biological Point Detection System
JCAD Joint Chemical Agent Detector
JCAS Joint Command and Control Attack Simulation
JECEWSI Joint Electronic Combat Electronic Warfare Simulation
   ACRONYM Full Title
JEM Joint Effects Model
JFACC Joint Force Air Component Commander
JLNBCRV Joint Lightweight NBC Reconnaissance System
JLSCAD Joint Lightweight System for Chemical Agent Detection
JMASS Joint Modeling and Simulation System
JMIST Joint Modeling for IO Simulation & Training
JNETS Joint Network Simulation
JOC Job Order Contract
JOISIM Joint Information Operations Center (JIOC) Operations, and Intelligence, Surveillance, and Reconnaissance (ISR) Simulation
JPEO-CBD Joint Program Executive Office for Chemical and Biological Defense
JPMG Joint Program Manager—Guardian
JQUAD Joint Electronic Combat/Electronic Warfare Simulation, Joint Command and Control (C2) Attack Simulation, Joint Network Simulation, and Joint Operations Information Simulation
JSB Joint Synthetic Battlespace
JSF Joint Strike Fighter
JSLIST Joint Service Lightweight Integrated Suit Technology
JSLSCAD Joint Services Lightweight Standoff Chemical Agent Detector
JSRG Joint Service Review Group
JTA Joint Technical Architecture
JTR Joint Travel Regulations
JWARS Joint Warfare System
K$ One Thousand Dollars
   ACRONYM Full Title
KM Knowledge Management
LAN Local Area Network
LCET Logistics Cost Estimating Tool
LE Logistics Engineer
LI Long Island (New York)
LM Lockheed Martin
LM21 Lockheed Martin 21st Century Quality Initiative
LMES Lockheed Martin Engineering Services
LMFC Lockheed Martin Finance Corporation
LMFCS Lockheed Martin Field Services Company LMMES Lockheed Martin Manassas Engineering Services LMMS Lockheed Martin Mission Systems
LM-MS2 Lockheed Martin—Maritime Systems & Sensors
LRU Line Replaceable Unit, or Lowest Replaceable Unit
LSI Lead Systems Integrator
M21 Automatic Chemical Agent Alarm
MC Maintenance Control
MCS Maneuver Control System
Mgt Management
MI Minority Institution
MICAD Multi-purpose Integrated Chemical Agent Alarm/Detector
MMAS Materials Management and Accounting System
MO Minority Owned
MOA Memorandum of Agreement
   ACRONYM Full Title
MOE Measurement of Effectiveness
MOP Measures of Performance
MOPP Mission Oriented Protective Posture
MOU Memorandum of Understanding
MOXA MOXA Technology Company
MPEG Motion Picture Experts Guild
MRP Materials Requisition Process
M&S Modeling and Simulation
MS Mission Sustainment
MS2 Maritime Systems & Sensors
MT Management Team
MTBF Mean Time Between Failures
NASM National Air and Space Warfare Models
NBC Nuclear Biological Chemical
NBCDACS Nuclear Biological Chemical Detection Analysis Communication System
NCBRS Nuclear Chemical Biological Reconnaissance System
NDI Non-Developmental Item
NE&SS Naval Electronics & Surveillance Systems
NET New Equipment Training
NFPA National Fire Protection Agency
N&GS Navigation & Gravity Systems
NGS Navigation and Gravity Systems
NIC Network Interface Card
NIOSH National Institute of Occupational Safety and Health
   ACRONYM Full Title
NIPRNET Non Secure Internet Protocol Router Network
NISPOM National Industrial Security Program Operating Manual
NLT New Leader Training, or No Later Than
NOT New Organizational Training
NRE Non Recurring Engineering
NSCMP Non-Stockpile Chemical Materiel Product
NTCR Non-Time Critical Removal
NTDA Network Targeting Decision Aid
NTE Not to Exceed
NTS Nevada Test Site
OCI Organizational Conflict of Interest
OCONUS Outside the Continental United States
OEM Original Equipment Manufacturer
OJT On the Job Training
O&M Operations and Maintenance
OPNET Modeling and Simulation Product Name
OSCP On-Scene Command Post
OSCP/ECP On-Scene Command Post/Entry Control Point
OSHA Occupational Safety and Health Administration
OT Overtime
OTCP Overarching Test Concept Plan
OV-6c Operational View-6c
PA Public Address
PAPR Powered Air Purifying Respirator
   ACRONYM Full Title
PBL Performance-Based Logistics
PC Personal Computer
PCD Program Control Directive
PCMS Program Control Management System
PCR Polymerase Chain Reaction
PDA Personal Digital Assistant
PDM Product Data Model
PDR-77 A Radiac Meter
PEO Program Executive Office
PEW Performance Evaluation Worksheet
PFPA Pentagon Force Protection Agency
PHST Packaging, Handling, Storage, and Transportation
PM Program Manager
PMO Program Management Office
PMR Program Management Review
PO Purchase Order
POC Point of Contact
PPE Personnel Protective Equipment
PRAT Performance Risk Analysis Team
Prev Preventative
PRI/DJI Project Resources Inc.
PS&H Packaging, Shipping and Handling
PTD Provisioning Technical Documentation
PTZ Pan-Tilt-Zoom
   ACRONYM Full Title
PX Post Exchange
QA Quality Assurance
QEM® Quantitative Emergency Management
QPL Qualified Parts List
R1 Designation for Sample TD Building Housing Security and Post Command
R2T2 Rapid Response Technology Trade Study
RAD Radiological
RAD-MAT Radioactive Material
RAM Reliability, Availability, and Maintainability
RAPID Ruggedized Advanced Pathogen Identification System
RCI Rapid COTS Insertion
RDTE Research, Development, Test, and Evaluation
RFI Request For Information
RFID Radio Frequency Identification
RFP Request for Proposal
RFQ Request for Quotation
RIC Rotating Inventory Control
RMA Reliability, Maintainability and Availability
RMI Remote Method Invocation
RMP Risk Management Plan
RT Repair Time, or Restoration Time
RTI Run-Time Infrastructure for Simulation Systems
RTM™ Requirements Traceability Management™
RTP™ Real Time Project™
   ACRONYM Full Title
SAM Situation Assessment Module
SARSIM Search and Rescue Simulation
SASR Strategic Airport Security Rollout
SAT Systems Approach to Training
SB Small Business
SBA Small Business Administration
SBCCOM Soldier and Biological Chemical Command
S&C Designation of Chemical Plant in Sample TD
SCOP Subcontractor On Premise
SDB Small Disadvantaged Business
SDMC Space and Missile Defense Command
SDVET Service Disabled Veteran Owned Small Business
SDVO Service Disabled Veteran Owned Small Business
SEI Software Engineering Institution
SEMP System Engineering Management Plan
SENTRY Product name by ENSCO Company
SESAME Selected Essential-item Stock for Availability Method
SF&I System Fielding and Integration
SIGINT Signal Intelligence
SIL Systems Integration Laboratory
SILC Supportability Integrated Logistics Console
Sim Simulation
SIRS Salary Information Retrieval System
SK Sample TD Building Designation
   ACRONYM Full Title
SLAB Dispersion Model that simulates atmospheric dispersion
SLVR Submarine LF/VLF Receiver
SME Subject Matter Expertise, or Subject Matter Expert
SOA State-of-the-Art
SOAP Simple Object Access Protocol
SOP Standard Operating Procedure
SOS Source of Supply
SOW Statement of Work
SPAR Superior Predictive Analyzer of Resources, registered trademark of Clockwork Solutions
SPAWAR Space and Naval Warfare Systems Command
SPI Schedule Performance Index
SQL Structured Query Language
SSA Source Selection Authority
SSAC Source Selection Advisory Committee
SSEB Source Selection Evaluation Board
SSEP Source Selection Evaluation Plan
SV Schedule Variance
SV-1 System View 1
SVCU SensorView Control Unit
SVRU SensorView Remote Unit
SVRUAA SensorView Remote Unit Application Adapter
SW Software
TAT Turnaround Time
TAV Total Asset Visibility
   ACRONYM Full Title
TBMCS Theatre Battle Management Core Systems
TCP/UDP Transmission Control Protocol/User Datagram Protocol
TCPI To Complete Cost Performance Index
TCP/IP Transmission Control Protocol/Internet Protocol
TD Technical Directive, or Technical Documentation
TDMP Technical Directive Management Plan
T&I Test and Integration
TIC Toxic Industrial Chemical
TIM Technical Interchange Meeting
TNG Training
TOC Total Ownership Cost
TRADOC Training and Doctrine Command
TRR Test Readiness Review
TSA Transportation Security Administration
TSS Transportation & Security Solutions
TT Technical Team
TTP Techniques, Tactics, and Procedures
TTX Table Top Exercise(s)
TVI Name of a Shelter Manufacturer
UDP/IP User Data Protocol/Internet Protocol
UGCV Unmanned Ground Combat Vehicle
UGT Underground Nuclear Test
UID Unique Identification
URCD Urgent Requirements Capability Document
   ACRONYM Full Title
US United States
USAF United States Air Force
USASMDC U.S. Army Space and Missile Defense Command
USMC United States Marine Corps
USNORTHCOM United States Northern Command
USS Undersea Systems
UV-LIF Ultra Violet—Laser Induced Fluorescence
VET Veteran Owned Small Business
VLSTRACK Vapor, Liquid, Solid Tracking
VO Veteran Owned Small Business
VPP Voluntary Protection Program
WASP Web Applications and Services Platform
WAVES Wireless Audio Visual Emergency System
WBS Work Breakdown Structure
WBSID Work Breakdown Structure Identification
WMD Weapons of Mass Destruction
WOSB Woman Owned Small Business
XDR External Data Representation
XML eXtensible Markup Language

1. A method comprising:
establishing a metric for gauging the performance of a threat-protection system with respect to a site;
modeling a first threat as a function of a plurality of threat-protection elements; and
installing said threat-protection elements for Protection of said site based on results of said modeling.

2. The method of claim 1 wherein said metric is scenario specific.

3. The method of claim 1 wherein the operation of modeling further comprises iteratively modeling said first threat as a function of said plurality of threat-protection elements, wherein for each iteration, a characteristic of one of said threat-protection elements is changed, and wherein a value for said metric is derived for each iteration.

4. The method of claim 3 wherein the operation of modeling further comprises determining a sensitivity of said metric to at least some of said threat-protection elements.

5. The method of claim 3 wherein the operation of modeling further comprises determining a first group of characteristics of said plurality of threat-protection elements that provide a more desirable valuation for said metric than a valuation provided by a second group of characteristics of said plurality of threat protection elements.

6. The method of claim 5 wherein the operation of installing comprises installing said threat-protection elements that possess said first group of characteristics.

7. The method of claim 5 wherein said threat-protection elements having said first group of characteristics are non-optimal based on said metric.

8. The method of claim 1 wherein the operation of modeling further comprises using a hazard model, wherein said hazard model predicts the atmospheric dispersion of vapors, particles, or liquid droplets based on meteorological conditions.

9. The method of claim 1 wherein the operation of modeling further comprises using a sensor model, wherein said sensor model predicts the response of chemical sensors and biological sensors.

10. The method of claim 1 wherein the operation of modeling further comprises using a human response model, wherein said human response model evaluates the effectiveness of human response to a specified threat based on a particular concept of operation.

11. A method comprising:
establishing a metric for gauging the performance of a threat-protection system;
defining a first group of threat-protection materiel elements, wherein each threat-protection element in said first group is characterized by at least one quantitative measure;
modeling a first threat as a function of said first group of threat-protection materiel elements, wherein a first value for said metric is derived from said modeling;
defining a second group of threat-protection materiel elements by changing said quantitative measure of one of threat-protection elements of said first group; and
modeling said first threat as a function of said second group of threat-protection materiel elements, wherein a second value for said metric is derived from said modeling.

12. The method of claim 11 further comprising comparing said first value to said second value.

13. The method of claim 12 selecting one of said first value and said second value as a more desirable valuation of said metric.

14. The method of claim 12 comprising
installing said first group of threat-protection elements or said second group of threat protection elements based on which of these groups resulted in said more desirable valuation of said metric.

15. A method comprising:
receiving a first plurality of signals in a data processing system, wherein said first plurality of signals correspond to characteristics of a threat;
receiving a second plurality of signals in said data processing system, wherein said second plurality of signals correspond to characteristics of a first group of threat-protection materiel elements;
generating a third plurality of signals in said data processing system, wherein said third plurality of signals are based on said first plurality of signals and said second plurality of signals, and wherein said third plurality of signals are indicative of a first value of a metric for gauging performance of a threat-protection system in response to said threat;
receiving a fourth signal in said data processing system, wherein said fourth signal corresponds a change in a characteristic of said first group of threat-protection materiel elements, wherein said threat-protection materiel element having the changed characteristic and the threat-protection materiel elements having unchanged characteristics define a second group of threat-protection materiel elements; and
generating a fifth plurality of signals in said data processing system, wherein said fifth plurality of signals is based on said first plurality of signals and said fourth signal, and wherein said fifth plurality of signals is indicative of a second value of said metric for gauging performance of said threat-protection system in response to said threat.

16. The method of claim 15 wherein the operation of generating further comprises comparing said fourth plurality of signals to said fifth plurality of signals.

17. The method of claim 16 further comprising selecting one of said first group of threat-protection materiel elements or said second group of threat-protection materiel elements based on the comparison of said fourth plurality of signals to said fifth plurality of signals.

18. The method of claim 17 further comprising installing the selected group of threat-protection materiel elements.

19. The method of claim 15 wherein the operation of generating further comprises comparing said first value of said metric to said second value of said metric.

20. The method of claim 19 further comprising selecting one of said first group of threat-protection materiel elements or said second group of threat-protection materiel elements based on the comparison of said first value of said metric to said second value of said metric.

21. The method of claim 20 further comprising installing the selected group of threat-protection materiel elements.

22. The method of claim 15 further comprising determining a sensitivity of said metric to said threat-protection materiel element having the changed characteristic.
